(19) United States
(12) Patent Application Publication
(10) Pub. No.: US 2010/0182329 A1
(43) Pub. Date: Jul. 22, 2010

(54) INFORMATION STORAGE MEDIUM, SKELETON MOTION CONTROL DEVICE, AND SKELETON MOTION CONTROL METHOD

(75) Inventors: Kentaro YAMAGUCHI, Yokohama - shi (JP); Masanori YAMADA, Yokohama - shi (JP)

Correspondence Address: OLIFF & BERRIDGE, PLC, P.O. BOX 320850, ALEXANDRIA, VA, 22320-4850, US

(73) Assignee: NAMCO BANDAI GAMES INC., Tokyo (JP)

(21) Appl. No.: 12/690,434

(22) Filed: Jan. 20, 2010

(30) Foreign Application Priority Data
Jan. 21, 2009 (JP) 2009-11370

(51) Int. Cl. G06T 13/00

(52) U.S. Cl. 345/474

(57) ABSTRACT

A skeleton motion control device that control a motion of a skeleton model in which a parent bone and a child bone are linked via a joint. A movable range setting section sets a movable range of the joint on a projection plane, the projection plane being a plane that is orthogonal to an axis that connects a center point of a sphere and a focus that is a given point on the sphere surface, the center point of the sphere being the joint. A coordinate transformation section projects a point on the sphere surface onto the projection plane based on the focus, the point indicates a direction of the child bone. A skeleton motion calculation section calculates the direction of the child bone with respect to the parent bone within the movable range set by the movable range setting section based on a position of the point projected onto the projection plane.

Japanese Patent Application No. 2009-11370, filed on Jan. 21, 2009, is hereby incorporated by reference in its entirety.

### BACKGROUND OF THE INVENTION

The present invention relates to an information storage medium, a skeleton motion control device, and a skeleton motion control method.

A method that calculates the motion of a character (e.g., human or animal), a rope, cloth, or the like in a virtual three-dimensional space (object space) using a skeleton model has been known. The skeleton model is formed by linking a plurality of bones via joints, and the bones normally have a parent-child relationship. The motion of the child bone is calculated to follow the motion of the parent bone.

In the skeleton model, the joints may differ in degree of freedom or movable range. For example, a joint that corresponds to an elbow or a knee of a human body model has a low degree of freedom and tends to have a narrow movable range, and a joint that corresponds to a shoulder or the like has a high degree of freedom and tends to have a wide movable range.

When calculating the motion of the child bone corresponding to the motion of the parent bone, rotation information (e.g., the bend state of the child bone with respect to the parent bone or the twist state of the child bone with respect to the parent bone) is calculated. A related-art method expresses the direction of the child bone with respect to the parent bone using the rotation angle around each of three axes (x, y, z) based on the coordinate system of the parent bone.

However, when designing the motion of the skeleton model by merely applying the related-art method, the movable range of the joint may be unintentionally distorted when setting a wide movable range. This makes it difficult to implement a smooth motion of the character.

### SUMMARY

According to a first aspect of the invention, there is provided a computer-readable information storage medium storing a program that controls a motion of a skeleton model in which a parent bone and a child bone are linked via a joint, the program causing a computer to function as:

a movable range setting section that sets a movable range of the joint on a projection plane, the projection plane being a plane that is orthogonal to an axis that connects a center point of a sphere and a focus that is a given point on the sphere surface, the center point of the sphere being the joint;

a coordinate transformation section that projects a point on the sphere surface onto the projection plane based on the focus, the point indicates a direction of the child bone; and

a skeleton motion calculation section that calculates the direction of the child bone with respect to the parent bone within the movable range based on a position of the point projected onto the projection plane.

According to a second aspect of the invention, there is provided a skeleton motion control device that control a motion of a skeleton model in which a parent bone and a child bone are linked via a joint, the device comprising:

a movable range setting section that sets a movable range of the joint on a projection plane, the projection plane being a plane that is orthogonal to an axis that connects a center point of a sphere and a focus that is a given point on the sphere surface, the center point of the sphere being the joint;

a coordinate transformation section that projects a point on the sphere surface onto the projection plane based on the focus, the point indicates a direction of the child bone; and

a skeleton motion calculation section that calculates the direction of the child bone with respect to the parent bone within the movable range based on a position of the point projected onto the projection plane.

According to a third aspect of the invention, there is provided a skeleton motion control method that is implemented by a processor included in a skeleton motion control device to control a motion of a skeleton model in which a parent bone and a child bone are linked via a joint, the method comprising:

setting a movable range of the joint on a projection plane, the projection plane being a plane that is orthogonal to an axis that connects a center point of a sphere and a focus that is a given point on the sphere surface, the center point of the sphere being the joint;

projecting a point on the sphere surface onto the projection plane based on the focus, the point indicates a direction of the child bone; and

calculating the direction of the child bone with respect to the parent bone within the movable range based on a position of the point projected onto the projection plane.

### BRIEF DESCRIPTION OF THE SEVERAL VIEWS OF THE DRAWING

FIG. 1 is a functional block diagram of a skeleton motion control device according to one embodiment of the invention.

FIG. 2 is a diagram schematically illustrating the configuration of a skeleton model.

FIG. 3 is a diagram illustrating a coordinate system set for a parent bone and a child bone.

FIG. 4 is a diagram illustrating the relationship between rotation angles r_{y} and r_{z} and the position on a sphere surface S when using a triaxial rotation angle method.

FIG. 5 is a diagram illustrating a movable area of a joint set using the triaxial rotation angle method.

FIG. 6 is a diagram illustrating a movable area of a joint set using the triaxial rotation angle method.

FIG. 7 is a diagram illustrating a movable area of a joint set using the triaxial rotation angle method.

FIG. 8 is a diagram illustrating a movable area of a joint set using the triaxial rotation angle method.

FIG. 9 is a diagram illustrating a movable area of a joint set using the triaxial rotation angle method.

FIG. 10 is a diagram illustrating projection from a point P on a sphere surface S onto a point Q on a plane λ.

FIG. 11 is a diagram illustrating the result when projecting a grid on a plane λ onto a sphere surface S.

FIG. 12 is a diagram illustrating the relationship between a y-axis rotation angle r_{y} and an angle φ.

FIG. 13 is a diagram illustrating a comparison between the projection method and latitude/longitude representation.

FIG. 14 is a diagram illustrating a movable area of a joint set using the projection method.

FIG. 15 is a diagram illustrating a movable area of a joint set using the projection method.

FIG. 16 is a diagram illustrating a movable area of a joint set using the projection method.

FIG. 17 is a diagram illustrating a movable area of a joint set using the projection method.

FIG. 18 is a diagram illustrating a rectangularly restricted movable area on the plane λ.

FIG. 19 is a diagram illustrating an elliptically restricted movable area on the plane λ.

FIG. 20 is a diagram illustrating a movable area of a joint set using the projection method.

FIG. 21 is a diagram illustrating an ovally restricted movable area on the plane λ.

FIG. 22 is a diagram illustrating a movable area of a joint set using the projection method.

FIG. 23 is a diagram illustrating a movable area of a joint set using the projection method.

FIG. 24 is a diagram illustrating a foot Pₘ of a spherical perpendicular drawn from a point P to the boundary of a movable area.

FIG. 25 is a diagram illustrating a condition that a circle on the plane λ corresponds a great circle on the sphere surface S.

FIG. 26 is a diagram illustrating a circle obtained by projecting a spherical perpendicular onto the plane λ.

FIG. 27 is a diagram illustrating a spherical perpendicular drawn to the side of a rectangular area.

FIG. 28 is a diagram illustrating the nearest point region of each side of a rectangular area.

FIG. 29 is a diagram illustrating a problem that occurs due to a correction method using a simple solution when utilizing rectangular restriction.

FIG. 30 is a diagram illustrating a simple solution when utilizing elliptical restriction.

FIG. 31 is a diagram illustrating a problem that occurs due to a correction method using a simple solution when utilizing elliptical restriction.

FIG. 32 is a diagram illustrating a setting example of a movable area using a combination of an arc and a straight line.

FIG. 33 is a diagram illustrating a grid created on the sphere surface S while changing values q_{by} and q_{bz}.

FIG. 34 is a diagram that compares the pole-side state when using the projection method (left) and the pole-side state when using the quaternion method (right).

FIG. 35 is a diagram illustrating occurrence of collision at the boundary of a movable area.

FIG. 36 is a diagram illustrating occurrence of collision at the boundary of a movable area.

FIG. 37 is a diagram illustrating occurrence of collision at a constant acceleration.

FIG. 38 is a diagram illustrating convergence of repetitive repulsion.

FIG. 39 is a diagram illustrating repetitive collisions.

FIG. 40 is a flowchart illustrating a specific processing example of a method according to one embodiment of the invention.

FIG. 41 is a flowchart illustrating a specific processing example of a method according to one embodiment of the invention.

FIG. 42 is a diagram illustrating a hardware configuration example.

### DETAILED DESCRIPTION OF THE EMBODIMENT

The invention may provide an information storage medium, a skeleton motion control device, and a skeleton motion control method that implement a smooth motion of a character by advantageously providing the movable range of a joint.

(1) According to one embodiment of the invention, there is provided a computer-readable information storage medium storing a program that controls a motion of a skeleton model in which a parent bone and a child bone are linked via a joint, the program causing a computer to function as:

a movable range setting section that sets a movable range of the joint on a projection plane, the projection plane being a plane that is orthogonal to an axis that connects a center point of a sphere and a focus that is a given point on the sphere surface, the center point of the sphere being the joint;

a coordinate transformation section that projects a point on the sphere surface onto the projection plane based on the focus, the point indicates a direction of the child bone; and

a skeleton motion calculation section that calculates the direction of the child bone with respect to the parent bone within the movable range based on a position of the point projected onto the projection plane.

According to one embodiment of the invention, there is provided a skeleton motion control device comprising the above-described sections.

Note that the point that indicates the direction of the child bone on the sphere surface may be the intersection point of the child bone or an extension of the child bone and the sphere surface, for example.

According to the above embodiment, the movable range of the joint can be set widely in an orderly manner as compared with a normal joint movable range setting method by transforming the coordinates of a point on the sphere surface into coordinates on the projection plane by projection to set the movable range. This implements calculations that ensure a smooth motion of the skeleton model. For example, the skeleton model can be caused to make a motion using a method similar to a related-art method for a joint with a narrow movable range, while a more natural and smoother motion can be implemented for a joint with a wide movable range.

(2) In each of the information storage medium and the skeleton motion control device, the movable range setting section may set the movable range so that the shape of the movable area on the projection plane is a rectangle.

This facilitates determination of the movable range of the joint while allowing motion design of the skeleton model in the same manner as in the case of using a related-art method. Therefore, the skeleton model motion design environment can be improved.

(3) In each of the information storage medium and the skeleton motion control device, the movable range setting section may set the movable range so that the shape of the movable area on the projection plane is an ellipse.

This facilitates determination of the movable range of the joint while allowing motion design of the skeleton model in the same manner as in the case of using a related-art method. Therefore, the skeleton model motion design environment can be improved.

(4) In each of the information storage medium and the skeleton motion control device, the movable range setting section may set the movable range so that the shape of the movable area on the projection plane is an oval.

This facilitates determination of the movable range of the joint while allowing motion design of the skeleton model in the same manner as in the case of using a related-art method. Therefore, the skeleton model motion design environment can be improved.

(5) In each of the information storage medium and the skeleton motion control device,

an axis parallel to the parent bone may be set to be an x-axis, and two axes that are orthogonal to the parent bone and are orthogonal to each other are set to be a y-axis and a z-axis, respectively;

two coordinate axes on the projection plane that are orthogonal to each other may be set to be an s-axis and a t-axis, respectively; and

the coordinate transformation section may transform a point (x, y, z) on the sphere surface into a point (s, t) on the projection plane by a projection indicated by s=−z/(x+1) and t=y/(x+1) (where, x²+y²+z²=1) based on coordinate data of the focus.

According to this configuration, since transformation utilizing projection involves only four arithmetic operations, the calculation load can be reduced.

(6) In each of the information storage medium and the skeleton motion control device,

a rectangular shape, an elliptical shape, or an oval shape may be set in advance as the shape of the movable area on the projection plane, and allowable ranges of a rotation angle of the child bone around the y-axis and a rotation angle of the child bone around the z-axis with respect to the joint may be set in advance; and

the movable range setting section may set the movable range of the joint on the projection plane based on the shape of the movable area on the projection plane and the allowable ranges of the rotation angle of the child bone around the y-axis and the rotation angle of the child bone around the z-axis.

According to this configuration, the movable range of the joint can be easily set while effectively utilizing the skeleton model motion design technique of a related-art method.

(7) In each of the information storage medium and the skeleton motion control device, the skeleton motion calculation section may determine whether or not the direction of the child bone with respect to the parent bone obtained by calculating the motion of the child bone corresponding to the motion of the parent bone is within the movable range, and may correct the direction of the child bone with respect to the parent bone so that a condition corresponding to the shape of the movable area is satisfied when the direction of the child bone with respect to the parent bone is not within the movable range.

According to this configuration, the direction of the bone that ensures a natural motion can be calculated while reducing the calculation load.

(8) In each of the information storage medium and the skeleton motion control device, the skeleton motion calculation section may determine whether or not the direction of the child bone with respect to the parent bone obtained by calculating the motion of the child bone corresponding to the motion of the parent bone is within the movable range, may calculate a repulsion behavior in collision between the point projected onto the projection plane and a boundary of the movable range on the projection plane when the direction of the child bone with respect to the parent bone is not within the movable range, and may correct the direction of the child bone with respect to the parent bone.

According to this configuration, the direction of the bone that ensures a natural motion can be calculated while reducing the calculation load.

(9) In each of the information storage medium and the skeleton motion control device, the skeleton motion calculation section may calculate a time required for the repulsion behavior of the point projected onto the projection plane to converge when the repulsion behavior of the point projected onto the projection plane repeatedly occurs, and may terminate the repulsion behavior of the point projected onto the projection plane when the time is equal to or shorter than a predetermined time.

According to this configuration, a situation in which the repulsion behavior of the child bone does not converge (i.e., an unnatural motion occurs) can be prevented.

(10) In each of the information storage medium and the skeleton motion control device, the skeleton motion calculation section may correct the direction of the child bone with respect to the parent bone so that a condition corresponding to the shape of the movable area is satisfied when a point on the projection plane obtained by calculating the repulsion behavior of the point projected onto the projection plane at the boundary of the movable range is not within the movable range.

According to this configuration, an increase in calculation load due to repeated repulsion behavior calculations can be reduced.

(11) According to one embodiment of the invention, there is provided a skeleton motion control method that is implemented by a processor included in a skeleton motion control device to control a motion of a skeleton model in which a parent bone and a child bone are linked via a joint, the method comprising:

setting a movable range of the joint on a projection plane, the projection plane being a plane that is orthogonal to an axis that connects a center point of a sphere and a focus that is a given point on the sphere surface, the center point of the sphere being the joint;

projecting a point on the sphere surface onto the projection plane based on the focus, the point indicates a direction of the child bone; and

calculating the direction of the child bone with respect to the parent bone within the movable range based on a position of the point projected onto the projection plane.

Embodiments of the invention will now be described below. Note that the embodiments described below do not unduly limit the scope of the invention as stated in the claims. Also, not all the elements described below should be taken as essential requirements of the invention.

### 1. Configuration

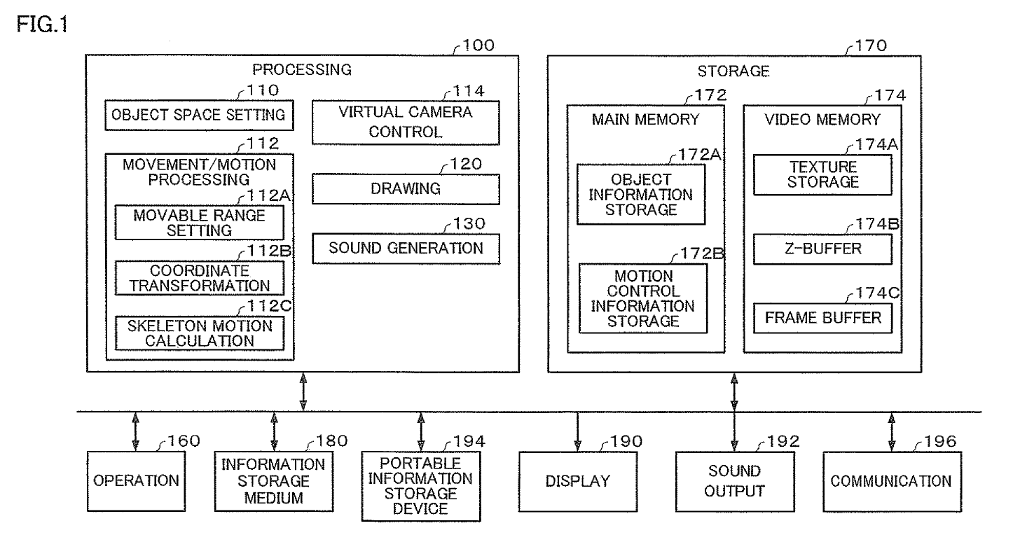

FIG. 1 illustrates an example of a functional block diagram of a skeleton motion control device (image generation device or game device) according to one embodiment of the invention. The skeleton motion control device according to this embodiment may have a configuration in which some of the elements (sections) illustrated in FIG. 1 are omitted.

An operation section 160 allows the operator to input operation data (input data) about a character (multi-joint model such as a human, animal, or robot). The function of the operation section 160 may be implemented by a lever, a button, a steering wheel, a microphone, a touch panel display, a casing, or the like. A storage section 170 serves as a work area for a processing section 100, a communication section 196, and the like. The function of the storage section 170 may be implemented by a RAM, a VRAM, or the like.

An information storage medium 180 (computer-readable medium) stores a program, data, and the like. The function of the information storage medium 180 may be implemented by an optical disk (CD or DVD), a magneto-optical disk (MO), a magnetic disk, a hard disk, a magnetic tape, a memory (ROM), or the like. The processing section 100 performs various processes according to this embodiment based on a program (data) stored in the information storage medium 180. Specifically, a program that causes a computer to function as each section according to this embodiment (i.e., a program that causes a computer to execute the process of each section) is stored in the information storage medium 180.

A display section 190 outputs an image generated according to this embodiment. The function of the display section 190 may be implemented by a CRT, an LCD, a touch panel display, a head mount display (HMD), or the like. A sound output section 192 outputs sound generated according to this embodiment. The function of the sound output section 192 may be implemented by a speaker, a headphone, or the like.

A portable information storage device 194 stores an operator's personal data, game save data, and the like. The portable information storage device 194 may be a memory card, a portable game device, or the like. The communication section 196 performs various control processes for communicating with the outside (e.g., host device or another skeleton motion control device). The function of the communication section 196 may be implemented by hardware (e.g., processor or communication ASIC), a program, and the like.

The program (data) that causes a computer to function as each section according to this embodiment may be distributed to the information storage medium 180 or the storage section 170 from an information storage medium included in a host device (server) via a network and the communication section 196. Use of the information storage medium included in the host device (server) is also included within the scope of the invention.

The processing section 100 performs a game process, an image generation process, a sound generation process, and the like based on operation data from the operation section 160, a program, and the like. The game process includes starting the game when game start conditions have been satisfied, proceeding with the game, disposing an object such as a character or a map, displaying an object, calculating the game result, finishing the game when game end conditions have been satisfied, and the like. The processing section 100 performs various processes using the storage section 170 as a work area. The function of the processing section 100 may be implemented by hardware such as a processor (e.g., CPU, GPU, or DSP) or an ASIC (e.g., gate array), or a program.

The processing section 100 includes an object space setting section 110, a movement/motion processing section 112, a virtual camera control section 114, a drawing section 120, and a sound generation section 130. The processing section 100 may have a configuration in which some of these sections are omitted.

The object space setting section 110 disposes an object (i.e., an object formed by a primitive such as a polygon, free-form surface, or subdivision surface) that represents a display object (e.g., character, building, stadium, car, tree, pillar, wall, road, or map (topography)) in an object space based on object information stored in an object information storage section 172A of a main memory 172. Specifically, the object space setting section 110 determines the position and the rotation angle (synonymous with orientation or direction) of the object in a world coordinate system based on the processing results of the movement/motion processing section 112, and disposes the object at the determined position (X, Y, Z) and the determined rotation angles (rotation angles around X, Y, and Z axes).

The movement/motion processing section 112 calculates the movement (displacement) and the motion (movement/motion simulation) of the object (e.g., character). Specifically, the movement/motion processing section 112 causes the object to move or make a motion (animation) in the object space based on the operation data input by the operator using the operation section 160, a program (movement/motion algorithm), various types of data (motion data), and the like. More specifically, the movement/motion processing section 112 performs a simulation process that sequentially calculates movement information (position, rotation angle, speed, or acceleration) and motion information (i.e., the position or the rotation angle of each part that forms the object) about the object every frame ( 1/60th of a second). Note that the term “frame” used herein refers to a time unit employed when performing an object movement/motion process (simulation process) or an image generation process.

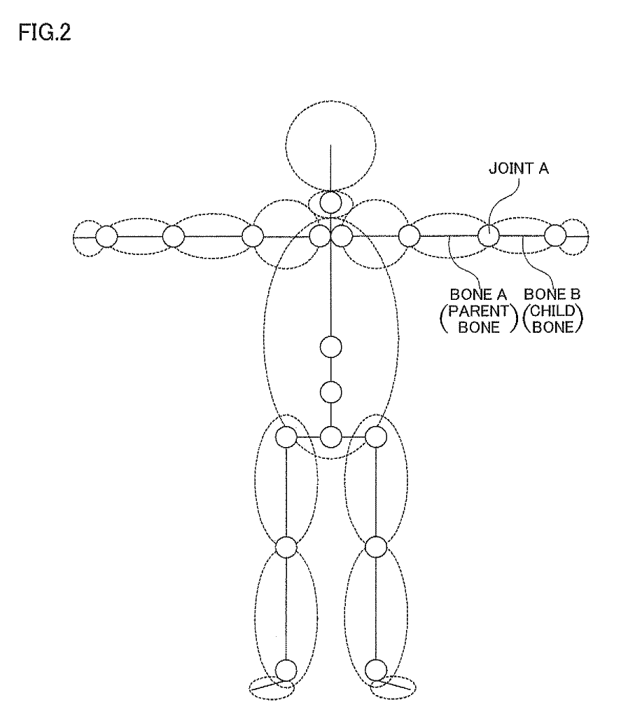

In this embodiment, the motion of the object is determined using a skeleton model illustrated in FIG. 2 that includes a plurality of bones that are linked via joints, the motion of each bone being determined so that a child bone follows the motion of a parent bone, the child bone and the parent bone being linked via a single joint. In the example of the skeleton model illustrated in FIG. 2, a bone A and a bone B linked via a joint A respectively correspond to the parent bone and the child bone. The movement/motion processing section 112 includes a movable range setting section 112A, a coordinate transformation section 112B, and a skeleton motion calculation section 112C.

The movable range setting section 112A sets the movable range of the joint on a projection plane, the projection plane is a plane that is orthogonal to an axis that connects a center point of a sphere and a focus that is a given point on the sphere surface, and the center point of the sphere is the joint. The movable range may be set to be an area having a rectangular shape, an elliptical shape, or an oval shape on the projection plane.

In this embodiment, a rectangular shape, an elliptical shape, or an oval shape is set in advance as the shape of the movable area of the joint of the skeleton model on the projection plane, and the allowable ranges of the rotation angle of the child bone around a y-axis (y-axis rotation angle) and the rotation angle of the child bone around a z-axis (z-axis rotation angle) are set in advance. Specifically, shape pattern information that indicates the shape of the movable area of each joint and allowable range information that indicates the allowable ranges of the y-axis rotation angle and the z-axis rotation angle of each joint are stored in a motion control information storage section 172B of the main memory 172. The movable range setting section 112A sets the movable range of the joint on the projection plane based on the shape of the movable area of the calculation target joint on the projection plane obtained from the shape pattern information and the allowable ranges of the y-axis rotation angle and the z-axis rotation angle of the calculation target joint obtained from the allowable range information.

The coordinate transformation section 112B projects a point on the sphere surface onto the projection plane based on the focus, the point indicates a direction of the child bone, a center point of the sphere being the joint. In this embodiment, an axis along the parent bone is set to be an x-axis, and two axes that are orthogonal to the parent bone and are orthogonal to each other are set to be a y-axis and a z-axis, respectively. Coordinate axes on the projection plane that are orthogonal to each other are set to be an s-axis and a t-axis. The coordinate transformation section 112B transforms a point (x, y, z) on the sphere surface into a point (s, t) on the projection plane by projection indicated by s=−z/(x+1) and t=y/(x+1) (where, x²+y²+z²=1) based on coordinate data of the focus.

The skeleton motion calculation section 112C calculates the direction of the child bone with respect to the parent bone within the movable range set by the movable range setting section 112A based on the position of the point projected onto the projection plane. The skeleton motion calculation section 112C determines whether or not the direction of the child bone with respect to the parent bone obtained by calculating the motion of the child bone corresponding to the motion of the parent bone is within the movable range based on input information input from the operation section 160, external force information based on collision (hit) between the objects, motion-affecting information (e.g., gravity information and wind force information), and the like. When the direction of the child bone with respect to the parent bone is not within the movable range, the skeleton motion calculation section 112C corrects the direction of the child bone with respect to the parent bone so that a condition corresponding to the shape of the movable area on the projection plane is satisfied, and determines the direction of the child bone so that the direction of the child bone is within the movable range of the calculation target joint.

The skeleton motion calculation section 112C calculates a repulsion behavior that occurs when the point projected onto the projection plane collides against the boundary of the movable range formed on the projection plane when the direction of the child bone with respect to the parent bone is not within the movable range, on condition that the repulsion behavior of the child bone is allowed for the calculation target joint, and corrects the direction of the child bone with respect to the parent bone. In this embodiment, the repulsion behavior is calculated by approximating the motion of the point on the projection plane per frame (e.g., 1/60th of a second) to a uniform linear motion. When the repulsion behavior of the point projected onto the projection plane repeatedly occurs, the time required for the repulsion behavior of the point projected onto the projection plane to converge is calculated, and the repulsion behavior of the point projected onto the projection plane is terminated when the time is equal to or shorter than a given time.

The movement/motion processing section 112 causes the object to make a motion by deforming the polygon or the like (surface shape) that forms the surface of the object based on the calculation results of the skeleton motion calculation section 112C.

The virtual camera control section 114 controls a virtual camera (viewpoint) for generating an image viewed from a given (arbitrary) viewpoint in the object space. Specifically, the virtual camera control section 114 controls the position (X, Y, Z) or the rotation angles (rotation angles around X, Y, and Z-axes) of the virtual camera (i.e., controls the viewpoint position, the line-of-sight direction, or the angle of view).

For example, when photographing the object (e.g., car, character, or ball) from behind using the virtual camera, the virtual camera control section 114 controls the position or the rotation angle (direction) of the virtual camera so that the virtual camera follows a change in position or rotation of the object. In this case, the virtual camera control section 114 may control the virtual camera based on information (i.e., given control information) about the position, rotation angle, or speed of the object obtained by the movement/motion processing section 112. Alternatively, the virtual camera control section 114 may rotate the virtual camera by a predetermined rotation angle, or may move the virtual camera along a predetermined path. In this case, the virtual camera control section 114 controls the virtual camera based on virtual camera data (i.e., given control information) that specifies the position (moving path) or the rotation angle of the virtual camera. When a plurality of virtual cameras (viewpoints) are provided, the virtual camera control section 114 performs the above control process on each virtual camera.

The drawing section 120 performs a drawing process based on the results of various processes (e.g., game process or skeleton motion calculation process) performed by the processing section 100 to generate an image, and outputs the generated image to the display section 190. When generating a three-dimensional game image, the drawing section 120 receives object information (model information) including vertex data (e.g., vertex position coordinates, texture coordinates, color data, normal vector, or α-value) of each vertex of the object (model), and performs a vertex process (shading using a vertex shader) based on the vertex data included in the received object information. When performing the vertex process, the drawing section 120 may perform a vertex generation process (tessellation, surface division, or polygon division) for dividing the polygon, if necessary. In the vertex process, the drawing section 120 performs a vertex movement process and a geometric process such as coordinate transformation (world coordinate transformation or camera coordinate transformation), clipping, or perspective transformation based on a vertex processing program (vertex shader program or first shader program), and changes (updates or adjusts) the vertex information about each vertex that forms the object based on the processing results. The drawing section 120 then performs a rasterization process (scan conversion) based on the vertex information changed by the vertex process so that the surface of the polygon (primitive) is linked to pixels. The drawing section 120 then performs a pixel process (shading using a pixel shader or a fragment process) that draws the pixels that form the image (fragments that form the display screen). In the pixel process, the drawing section 120 determines the drawing color of each pixel that forms the image by performing various processes such as a texture reading (texture mapping) process, a color information setting/change process, a translucent blending process, and an anti-aliasing process based on a pixel processing program (pixel shader program or second shader program), and outputs (draws) the drawing color of the object subjected to perspective transformation to a frame buffer 174C (i.e., a buffer that can store image information corresponding to each pixel) of a video memory 174 (rendering target). Specifically, the pixel process includes a per-pixel process that sets or changes the image information (e.g., color, normal, luminance, and α-value) corresponding to each pixel. The drawing section 120 thus generates an image viewed from the virtual camera (given viewpoint) in the object space. When a plurality of virtual cameras (viewpoints) are provided, the drawing section 120 may generate an image so that images (segmented images) viewed from the respective virtual cameras are displayed on a single screen.

The vertex process and the pixel process are implemented by hardware that enables a programmable polygon (primitive) drawing process (i.e., a programmable shader (vertex shader and pixel shader)) based on a shader program written in shading language. The programmable shader enables a programmable per-vertex process and a per-pixel process to increase the degree of freedom of the drawing process so that the representation capability can be significantly improved as compared with a fixed drawing process using hardware.

The drawing section 120 performs a geometric process, a texture mapping process, a hidden surface removal process, an alpha blending process, and the like when drawing the object.

In the geometric process, the drawing section 120 subjects the object to coordinate transformation, clipping, perspective projection transformation, light source calculations, and the like. The object information (e.g., object's vertex position coordinates, texture coordinates, color data (luminance data), normal vector, or α-value) after the geometric process (after perspective transformation) is stored in an object information storage section 172A of the main memory 172.

The term “texture mapping” refers to a process that maps a texture (texel value) stored in a texture storage section 174A of the video memory 174 onto the object. Specifically, the drawing section 120 reads a texture (surface properties such as color (RGB) and α-value) from the texture storage section 174A using the texture coordinates that are set (assigned) to the vertices of the object and the like. The drawing section 120 maps the texture (two-dimensional image) onto the object. In this case, the drawing section 120 performs a pixel-texel link process, a bilinear interpolation process, a trilinear interpolation process (texel interpolation process), and the like.

The drawing section 120 may perform a hidden surface removal process by a Z-buffer method (depth comparison method or Z-test) using a Z-buffer 174B (depth buffer) that stores the Z-value (depth information) of the drawing pixel. Specifically, the drawing section 120 refers to the Z-value stored in the Z-buffer 174B when drawing the drawing pixel corresponding to the primitive of the object. The drawing section 120 compares the Z-value stored in the Z-buffer 174B with the Z-value of the drawing pixel of the primitive. When the Z-value of the drawing pixel is a Z-value in front of the virtual camera (e.g., a small Z-value), the drawing section 120 draws the drawing pixel and updates the Z-value stored in the Z-buffer 174B with a new Z-value.

The drawing section 120 performs a translucent blending process (e.g., normal alpha blending, additive alpha blending, or subtractive alpha blending) based on the α-value (A-value). When performing normal alpha blending, the drawing section 120 performs a process shown by the following expressions (α1) to (α3).

RQ=(1−α)×R1+α×R2 (α1)

GQ=(1−α)×G1+α×G2 (α2)

BQ=(1−α)×B1+α×B2 (α3)

When performing additive alpha blending, the drawing section 120 performs a process shown by the following expressions (α4) to (α6). Note that the drawing section 120 performs the process shown by the expressions (α4) to (α6) in which α=1 when performing simple additive alpha blending.

RQ=R1+α×R2 (α4)

GQ=G1+α×G2 (α5)

BQ=B1+α×B2 (α6)

When performing subtractive alpha blending, the drawing section 120 performs a process shown by the following expressions (α7) to (α9). Note that the drawing section 120 performs the process shown by the expressions (α7) to (α9) in which α=1 when performing simple subtractive alpha blending.

RQ=R1−α×R2 (α7)

GQ=G1−α×G2 (α8)

BQ=B1−α×B2 (α9)

R1, G1, and B1 represent the RGB components of the image (original image) that has been drawn in the frame buffer 174C of the video memory 174, and R2, G2, and B2 represent the RGB components of the image to be drawn in the frame buffer 174C. RQ, GQ, and BQ represent the RGB components of the image obtained by alpha blending. Note that the α-value is information that can be stored corresponding to each pixel (texel or dot), such as additional information other than the color information. The α-value may be used as mask information, translucency (equivalent to transparency or opacity), bump information, or the like.

The sound generation section 130 performs sound processing based on the results for various processes performed by the processing section 100 to generate sound such as background music (BGM), effect sound, or voice, and outputs the generated sound to the sound output section 192 (speaker).

The skeleton motion control device according to this embodiment may be a device dedicated to a single mode that allows only one operator to operate the device, or may be a device provided with a multi mode that allows a plurality of operators to operate the device. When a plurality of operators operate the device, an image and sound supplied to each operator may be generated by one terminal, or may be generated by a distributed process using a plurality of terminals (skeleton motion control devices, game devices, or portable telephones) connected via a network (transmission line or communication channel), for example.

### 2. Method According to One Embodiment of the Invention

A method according to one embodiment of the invention is described below by contrast with the related-art method.

### 2-1. Related-Art Method (Triaxial Rotation Angle Method)

### 2-1-1. Coordinate system

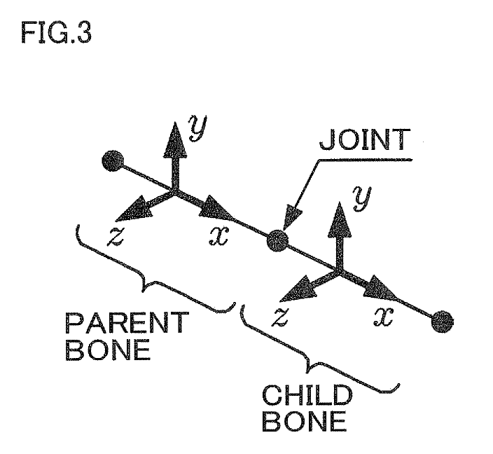

One of bones on either side of a given joint is referred to as “parent bone”, and the other bone is referred to as “child bone”. The rotation (bend or twist) of the joint can be expressed by the direction of the child bone with respect to the parent bone. A coordinate system is defined for each bone as illustrated in FIG. 3 in order to indicate the direction of each bone.

### 2-1-2. Triaxial Rotation Angle Representation

The related-art method expresses the direction of the child bone with respect to the parent bone by the triaxial rotation angles (rₓ, r_{y}, and r₂) in an xyz coordinate system, and sets the movable range based on the range of the rotation angle around (along) each axis. The child bone may be rotated in various orders. In the following example, the child bone is sequentially rotated around (along) the x-axis, the z-axis, and the y-axis based on the coordinate system of the parent bone.

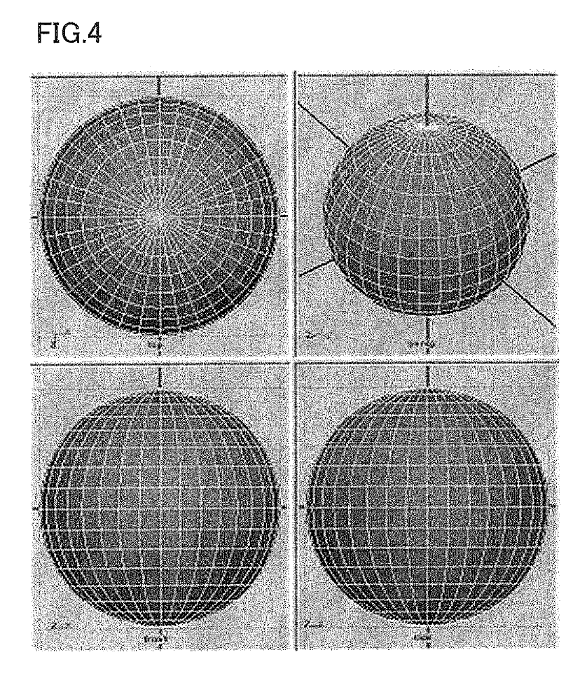

A sphere surface S having a radius 1 is formed around the joint (the center point of the sphere is the joint), and the intersection point of the x-axis of the child bone and the sphere surface S is referred to as P. In this case, the bend state of the joint is indicated by the position of the point P. The relationship among the triaxial rotation angles and the position of the point P is similar to the latitude and the longitude of a globe (see FIG. 4). In FIG. 4, the rotation angle is indicated at intervals of 10°. r_{y} corresponds to the longitude, r_{z} corresponds to the latitude, and rₓ corresponds to the twist at the position indicated by r_{y} and r_{z}.

### 2-1-3. Movable Range Setting

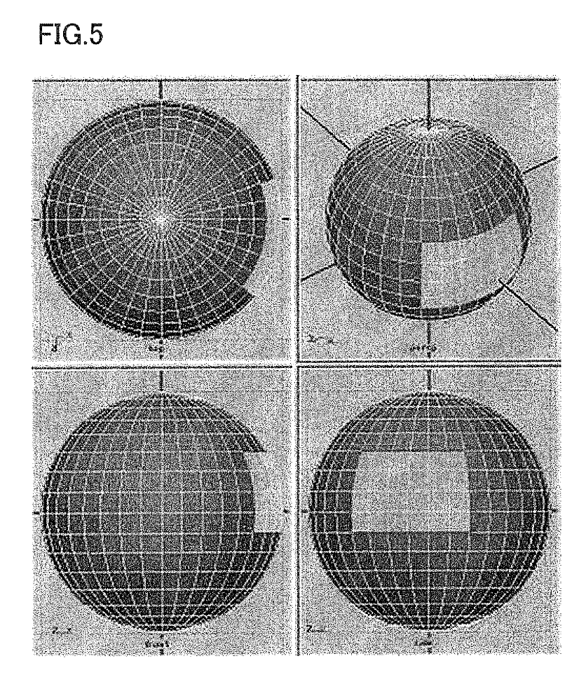

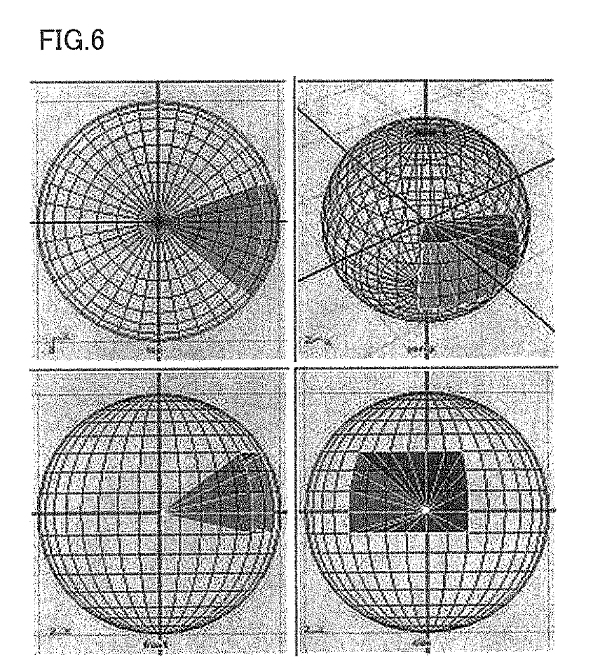

Setting the movable range (a movable area) of the bend angle of the joint corresponds to setting an area (hereinafter referred to as “movable area”). In the related art method, setting the movable range corresponds to setting the movable area (a movable surface) on the sphere surface S. For example, when the y-axis rotation angle is −40° to 20° and the z-axis rotation angle is −10° to 30°, the movable area is set on the sphere surface S as illustrated in FIG. 5. FIG. 6 illustrates a state in which the center of the sphere surface S is connected to the boundary of the movable area.

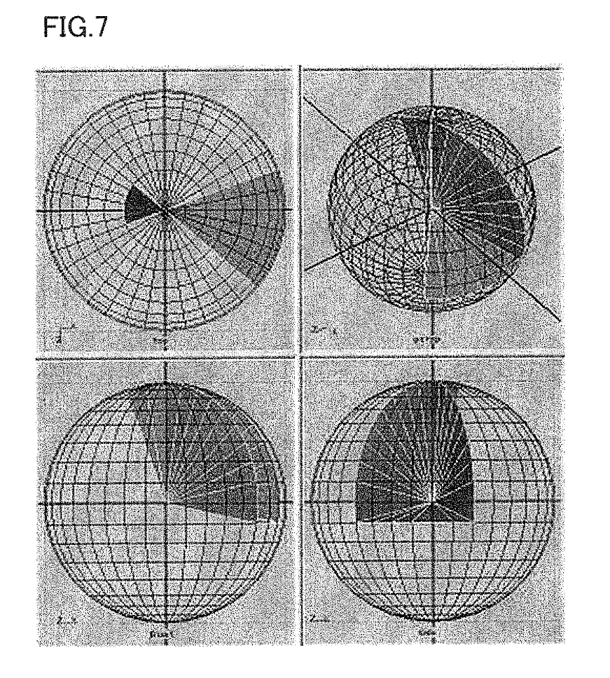

No problem occurs when the movable range of the bend angle of the joint is relatively narrow. However, a problem occurs when the movable range of z-axis rotation exceeds ±90°. This is because the latitude can be set only within the range of −90° to 90°, whereas the longitude can be set within the range of −180° to 180°. For example, when r_{y} is −40° to 20° and r_{z} is −10° to 110°, the movable area is set as illustrated in FIGS. 7 to 9. However, the shape of the movable area is distorted, or the movable area setting process becomes complex, as is clear from the setting examples illustrated in FIGS. 7 to 9.

### 2-2. Projection Method According to this Embodiment

### 2-2-1. Projection from Sphere Surface S onto Plane λ

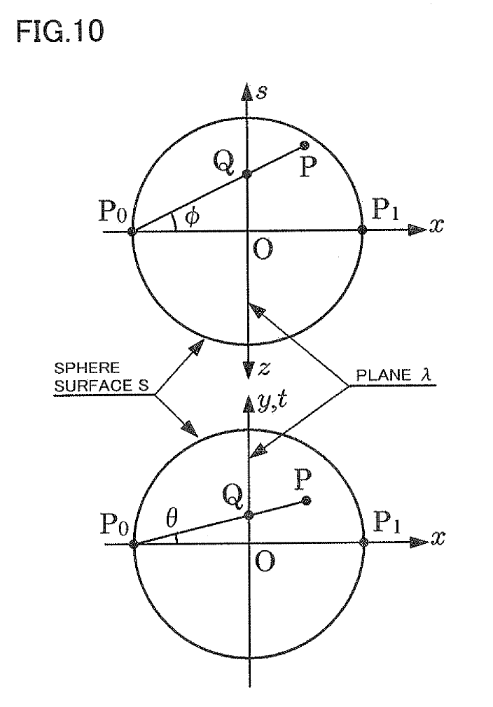

In the method according to this embodiment, as illustrated in FIG. 10, when the point at the coordinates (−1, 0, 0) is referred to as a point P₀ and the plane at x=0 is referred to as a plane λ (projection plane), an arbitrary point P on the sphere surface S is projected onto the plane λ with respect to the point P₀ (focus (light source)) to obtain a point Q. In this embodiment, projection of the point P on the sphere surface S onto the plane λ (point Q) is referred to as f, and transformation of the point P on the sphere surface S into the point Q on the plane λ is indicated by Q=f(P). Projection of the point Q on the plane λ onto the sphere surface S (point P) is referred to as f⁻¹, and transformation of the point Q on the plane λ into the point P on the sphere surface S is indicated by P=f⁻¹(Q). The point P₀ is referred to as the pole of the sphere surface S.

Based on the above preconditions, a point (excluding the point P₀) on the sphere surface S and a point on the plane λ have a one-to-one correspondence (bijection) by a projection f, and f(P₀) indicates the point at infinity on the plane λ. In the method according to this embodiment, the position of the point P on the sphere surface S is restricted by setting the movable area (the movable range on the projection plane) of the point Q on the plane λ to set the movable range that restricts the bend angle of the joint.

Specifically, the position of the point Q on the plane λ is expressed by an st coordinate system indicated by an s-axis and a t-axis that are orthogonal to each other. When the origin of the st coordinate system is a point f(P₁) obtained by transforming a point P₁ at the coordinates (1, 0, 0) on the sphere surface S, the point f(P₁) coincides with the origin of the xyz coordinate system that defines the sphere surface S.

In this embodiment, the positive s-axis direction (+s) corresponds to the negative z-axis direction (−z), and the positive t-axis direction (+t) corresponds to the positive y-axis direction (+y). Therefore, the point Q moves in the s direction when subjecting the point P in the zx plane to y-axis rotation, and moves in the t direction when subjecting the point P in the xy plane to z-axis rotation.

Transformation from the point P (coordinates (x, y, z)) to the point Q (coordinate (s, t)) by the projection f is shown by the following expression (1). Note that x²+y²+z²=1 is satisfied.

s=−z/(x+1)

t=y/(x+1) (1)

Transformation from the point Q to the point P by a projection f⁻¹ is shown by the following expression (2). Since the transformation result obtained by the projection f⁻¹ satisfies x²+y²+z²=1, the coordinate values obtained are normalized.

x=2/(s²+t²+1)−1

y=2t/(s²+t²+1)

z=−2s/(s²+t²+1) (2)

### 2-2-2. Relationship with Bend Angle of Joint

First, the relationship between the coordinates (s, t) of the point Q and angles φ and θ illustrated in FIG. 10 is shown by the following expression (3). Note that the range of the angle φ is −90°<φ<90°, and the range of the angle θ is −90°<θ<90°.

s=tan φ

t=tan θ (3)

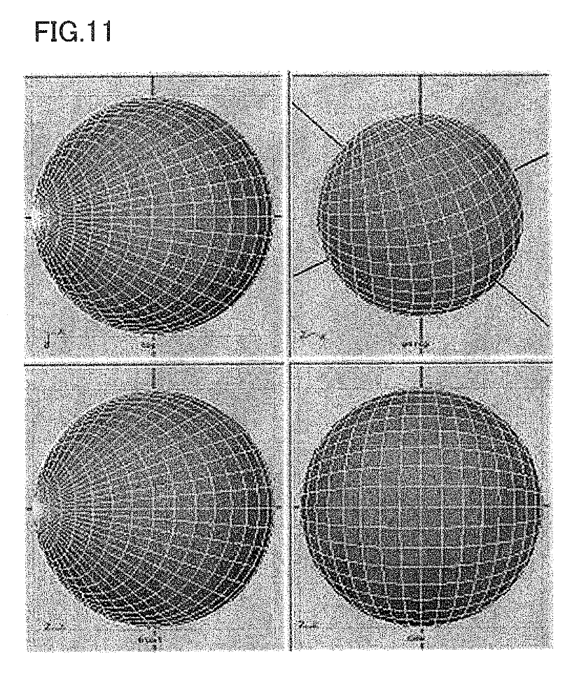

By creating a grid (grid line) on the plane λ, while changing the angles φ and θ from −85° to 85° at intervals of 5°, and projecting (f⁻¹) the grid onto the sphere surface S, an orthogonal grid illustrated in FIG. 11 is obtained.

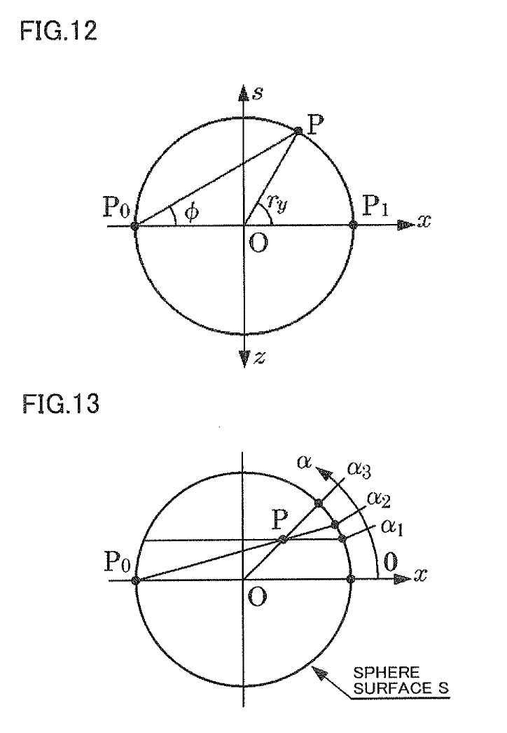

The relationship between the triaxial rotation angle method and the projection method according to this embodiment is described below. The relationship between the y-axis rotation angle r_{y} and the angle φ when the z-axis rotation angle r_{z} is 0 is illustrated in FIG. 12. This relationship is shown by the following expression (4).

∠P₀PO=∠PP₀O=φ

∠P₀PO+∠PP₀O=∠POP₁=r_{y}

∴φ=r_{y}/2 (4)

Second, the relationship between the z-axis rotation angle r_{z} and the angle θ when the y-axis rotation angle r_{y} is 0 is shown by θ=r_{z}/2. Therefore, if s and t respectively have a relationship shown by the following expression (5) with r_{y} and r_{z} when setting the movable range, the movable area obtained by the triaxial rotation angle method and the movable area obtained by the projection method according to this embodiment have almost the same shape when the absolute values of the y-axis rotation angle r_{y} and the z-axis rotation angle r_{z} are small, as illustrated in FIGS. 4 and 11.

s=tan(r_{y}/2)

t=tan(r₂/2) (5)

Third, a case where the position of the point P on the sphere surface S is indicated by an angular coordinate α (see FIG. 13) is described below. When the angular coordinate α corresponds to the latitude on the sphere surface S (i.e., the angular coordinate α corresponds to the z-axis rotation angle r_{z} in the triaxial rotation angle method), the coordinate of the point P is α₁. When the angular coordinate a corresponds to the longitude on the sphere surface S (i.e., the angular coordinate a corresponds to the y-axis rotation angle r_{y} in the triaxial rotation angle method), the coordinate of the point P is α₃. On the other hand, the coordinate of the point P is α₂ when using the projection method according to this embodiment. Specifically, the joint angle indicated by the projection method has an intermediate value between the value by latitude representation and the value by longitude representation by indicated by the triaxial rotation angle method. Therefore, the joint angle indicated by the projection method according to this embodiment does not differ to a large extent from the joint angle indicated by the triaxial rotation angle method so that a smooth method transition can be implemented.

### 2-2-3. Comparison Between Triaxial Rotation Angle Method and Projection Method According to this Embodiment

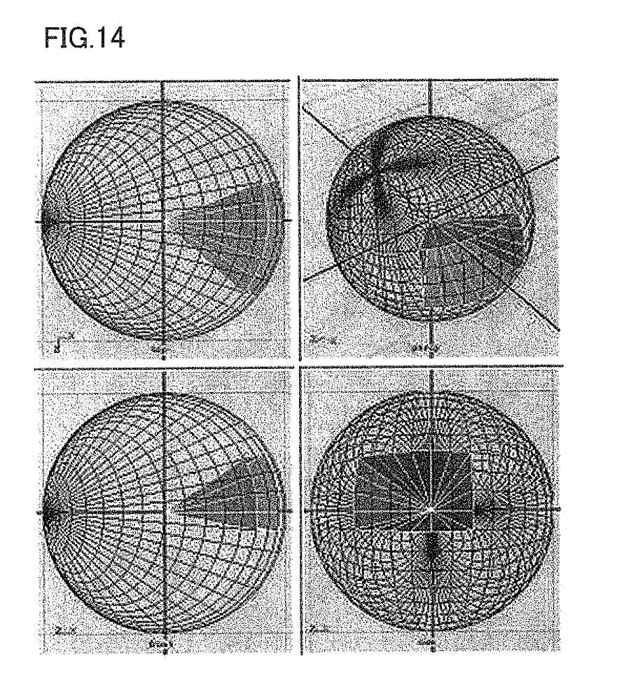

FIG. 14 illustrates a case where the movable area is rectangularly restricted using the projection method according to this embodiment when the range of s is tan−20° to tan 10° and the range of t is tan−5° to tan 15° (cf. FIG. 6). The details of rectangular restriction are described later in the section entitled “2-3-1. Rectangular restriction area setting method”.

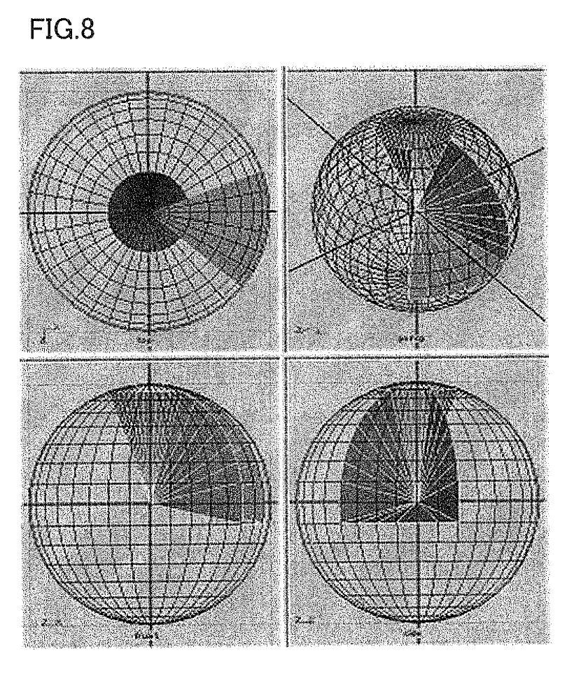

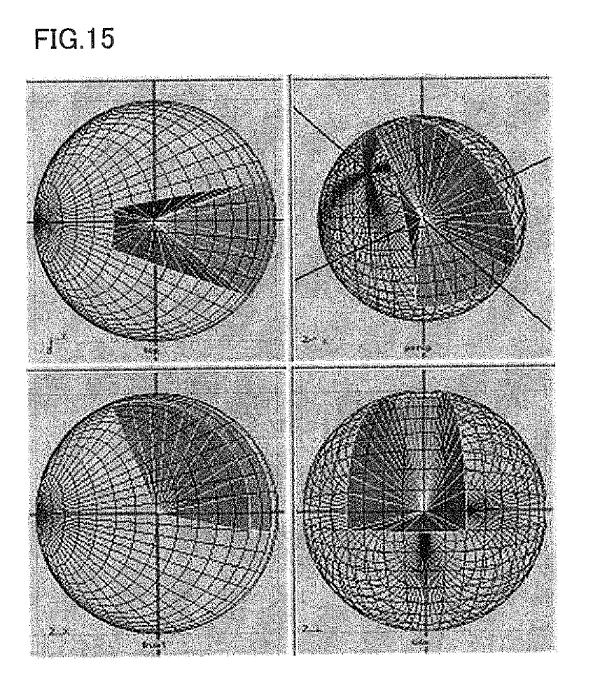

An example in which the z-axis rotation angle r_{z} exceeds ±90° is described below. FIG. 15 illustrates a case where the movable area is rectangularly restricted using the projection method according to this embodiment when the range of s is tan−20° to tan 10° and the range of t is tan−5° to tan 55° (cf. FIGS. 7 and 8).

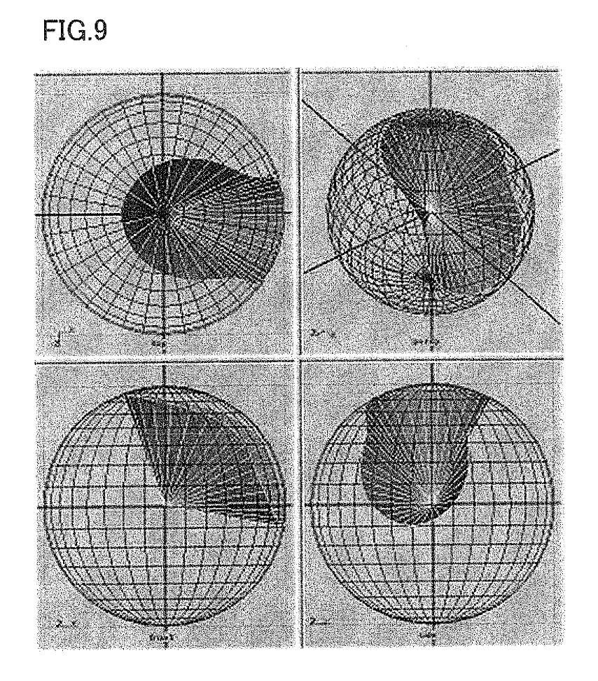

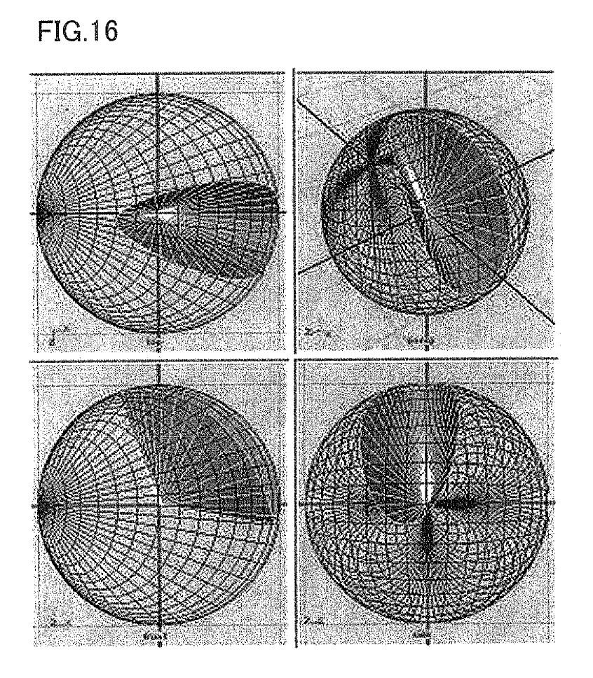

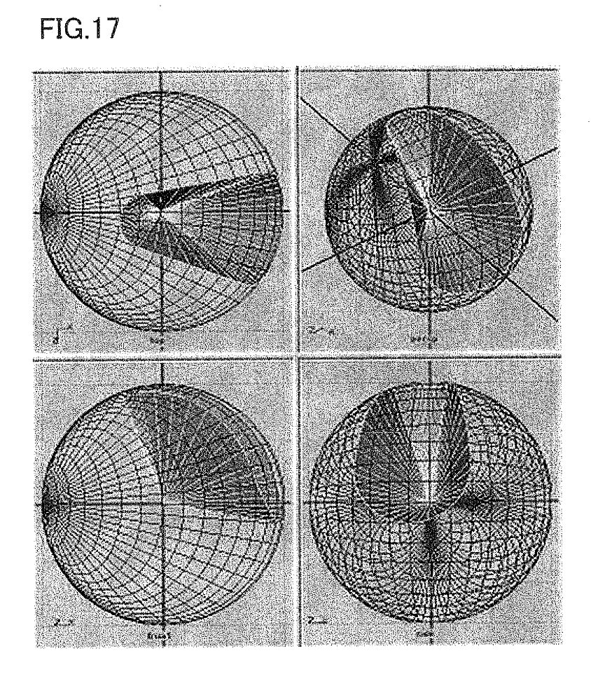

FIG. 16 illustrates a case where the movable area is elliptically restricted within the above ranges, and FIG. 17 illustrates a case where the movable area is ovally restricted within the above ranges (cf. FIG. 9). The details of elliptical restriction and oval restriction are described later in the section entitled “2-3-2. Elliptical restriction area setting method” and the section entitled “2-3-3. Oval restriction area setting method”, respectively.

The joint can be smoothly moved by utilizing the projection method according to this embodiment (see FIGS. 15 to 17), even when setting a wide movable area that exceeds ±90° that cannot be dealt with by the triaxial rotation angle method. Since a movable area having almost the same shape as that obtained by the triaxial rotation angle method can be obtained by the projection method according to this embodiment when setting a relatively narrow movable area for which the Y-axis rotation angle r_{y} and the z-axis rotation angle r, are about 0° to ±50° (see FIGS. 6 and 14), a transition from the triaxial rotation angle method is facilitated. The relationship between the projection method and the triaxial rotation angle method can be easily set using the expression (5).

### 2-3. Setting Method Corresponding to Shape of Movable Area

When setting the movable area using the projection method according to this embodiment, the movable area of the bend angle of the joint is set by restricting the ranges of s and t on the plane λ. The following description is given on the assumption that the ranges of s and t are set as shown by the following expression (6), unless otherwise indicated.

s₀≦s≦s₁

t₀≦t≦t₁ (6)

### 2-3-1. Rectangular Restriction Area Setting Method

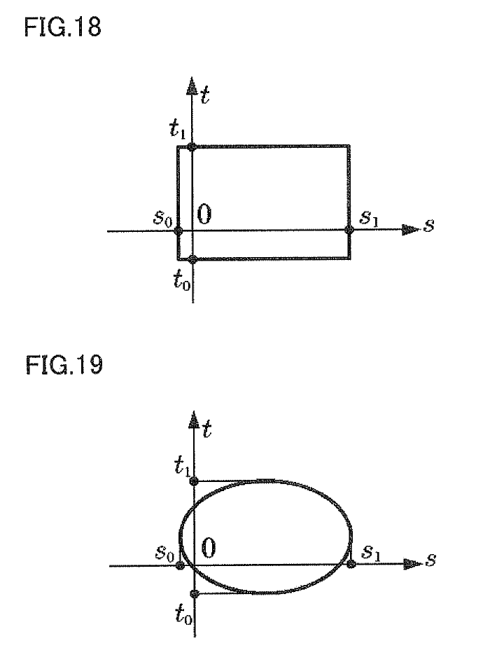

The term “rectangular restriction” refers to a method that sets a rectangular movable area on the plane λ, (see FIG. 18). Specifically, an area for which s and t satisfy the expression (6) is set to be the movable area. The actual joint movable area is set as illustrated in FIG. 14 or 15.

### 2-3-2. Elliptical Restriction Area Setting Method

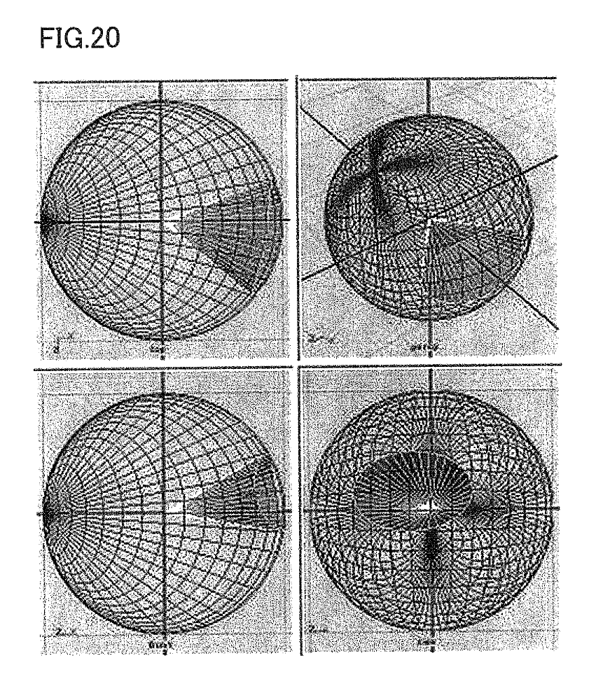

The term “elliptical restriction” refers to a method that sets an elliptical movable area on the plane λ (see FIG. 19). Specifically, the inside of an ellipse (an ellipse having axes that are parallel to the s-axis and the t-axis) that is inscribed to the area defined by s and t set using the expression (6) is set to be the movable area. The actual joint movable area is set as illustrated in FIG. 16 or 20.

Elliptical restriction is shown by the following expression (7).

[(s−s_{b})/sₐ]²+[(t−t_{b})/tₐ]²≦1 (7)

where, sₐ, s_{b}, tₐ, and t_{b} are defined by the following expression (8).

sₐ=(s₁−s₀)/2

s_{b}=(s₁+s₀)/2

tₐ=(t₁−t₀)/2

t_{b}=(t₁+t₀)/2 (8)

Elliptical restriction facilitates determination of the inside and the outside of the area. However, a correction method differing from that when employing rectangular restriction is required when the movable area is exceeded. The details thereof are described later.

### 2-3-3. Oval Restriction Area Setting Method

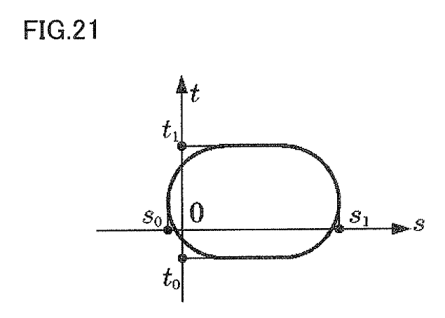

The term “oval restriction” refers to a method that sets an oval movable area on the plane λ (see FIG. 21). The boundary of the movable area is formed by semicircles and straight lines. FIG. 21 illustrates a case where sₐ>tₐ. The movable area illustrated in FIG. 21 has a horizontally long shape having straight lines at t=t₀ and t=t₁ (sₐ and tₐ are defined by the expression (8)). When sₐ<tₐ, the movable area has a vertically long shape obtained by rotating the movable area illustrated in FIG. 21 by 90°. When sₐ=tₐ, the movable area has a circular shape since the length of the straight line is zero.

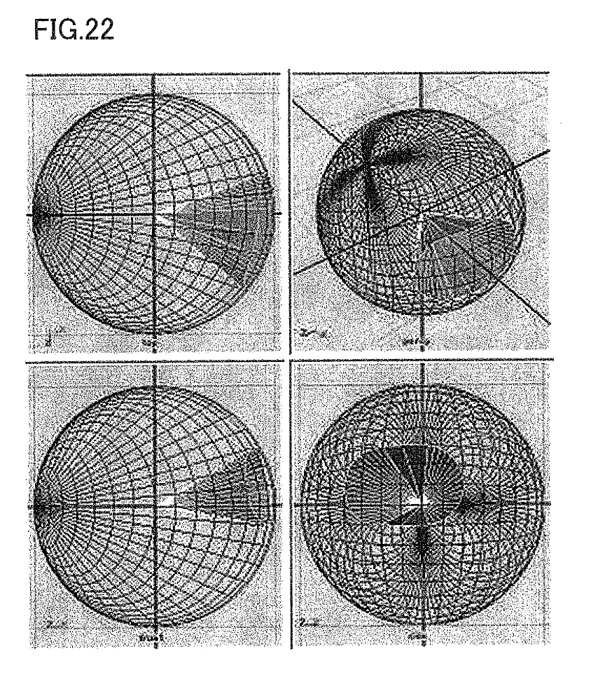

The actual joint movable area is set as illustrated in FIG. 17 or 22. The boundary of the movable area is formed by four small circles (refer to the section entitled “2-4-2. Features of projection f” for details). The term “small circle” used herein refers to a circle on the sphere surface that is defined by the sphere surface and a plane that intersects the sphere surface and does not pass through the center of the sphere (e.g., a parallel of the earth other than the equator is the small circle).

### 2-3-4. Super-Elliptical Restriction Area Setting Method

In the method according to this embodiment, elliptical restriction may be generalized to super-elliptical restriction. While elliptical restriction is indicated by the sum of squares, super-elliptical restriction is indicated by the sum of the mth power and nth power (see the following expression (9)).

(|s−s_{b}|/sₐ)^{m}+(|t−t_{b}|/tₐ)ⁿ≦1 (9)

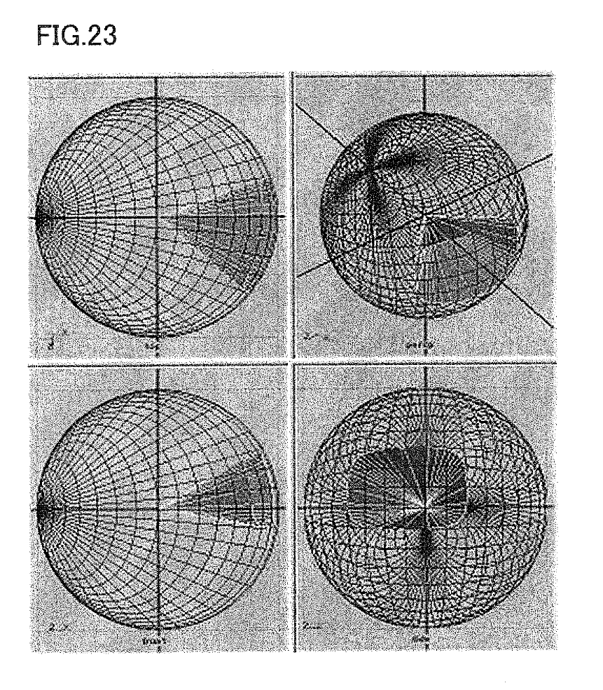

For example, when m=n=4 (the sum of the fourth power), the movable area is set as illustrated in FIG. 23 (cf. FIGS. 20 and 22). Elliptical restriction corresponds to the case where m=n=2 in the expression (9), and rectangular restriction corresponds to the case where m=n=∞ in the expression (9).

### 2-3-5. Area Setting Method Using Combination of Arc and Straight Line

It is also possible to set the movable area on the plane λ by combining arcs and straight lines instead of using super-elliptical restriction or a more complex shape. When correcting a value outside the movable area, an optimal solution cannot be algebraically calculated when utilizing super-elliptical restriction. On the other hand, an optimal solution can be algebraically calculated by utilizing an area shape formed by the combination of arcs and straight lines.

### 2-4. Correction Method when Movable Area is Exceeded

When the bend state of the joint exceeds the movable area, a correction for returning the bend state of the joint to the movable area is necessary. The correction method is described below.

### 2-4-1. Spherical Perpendicular and Optimal Solution

A movable area A is on the sphere surface S. The position of point P is outside the area A. The point P corrected to be set within the area A (including the boundary) is referred to as a point Pₘ. It is optimal to set a point within the area A that is positioned at the minimum distance (distance on the sphere surface S) from the point P to be the point Pₘ. The point Pₘ that satisfies this condition is referred to as “optimal solution”.

The term “spherical perpendicular” is defined as follows for convenience. When a point P and a curve L are given on the sphere surface 5, a great circle that passes through the point P and is orthogonal to the curve L is referred to as a spherical perpendicular drawn from the point P to the curve L, and the intersection point of the curve L and the spherical perpendicular is referred to as “foot” of the spherical perpendicular. The term “great circle” used herein refers to a circle on the sphere surface that is defined by the sphere surface and a plane that intersects the sphere surface and passes through the center of the sphere (e.g., the equator or meridian of the earth is the great circle).

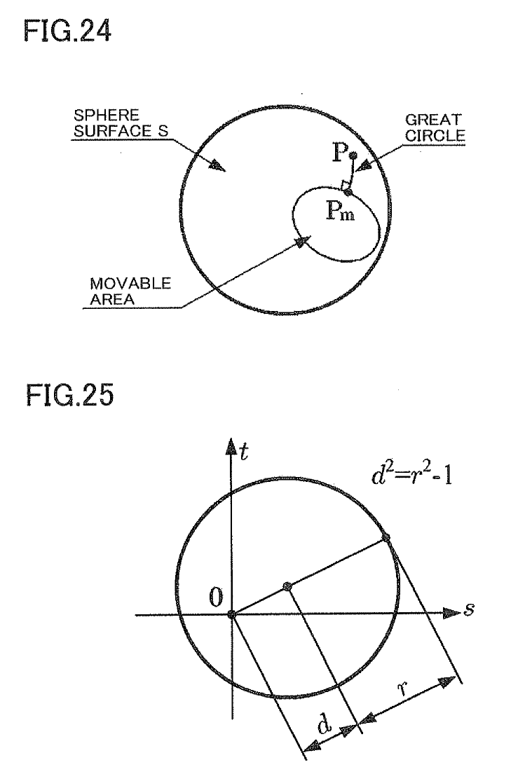

As illustrated in FIG. 24, the optimal solution of the point Pₘ is the foot of the spherical perpendicular that is drawn from the point P to the boundary of the movable area. When the area shape has a vertex (e.g., rectangular restriction), the vertex may be the optimal solution of the point Pₘ.

### 2-4-2. Features of Projection f

The projection f from the sphere surface S onto the plane 7 has the following features (A1) and (A2).

(A1) The angle formed by two lines does not change due to the projection f (i.e., conformal mapping).
(A2) A circle on the sphere surface S is projected onto the plane λ as a circle or a straight line, and vice versa.

Table 1 shows the detailed relationship between a circle on the sphere surface S and a circle or a straight line on the plane λ having a projective relationship. The condition C1 shown in Table 1 is satisfied when the following expression (10) (where, r is the radius of the circle, and d is the distance between the origin (0, 0) and the center of the circle; see FIG. 25) is satisfied.

TABLE 1

| Sphere surface S | | Plane λ |
|---|---|---|
| Great circle | Passes through pole P₀ | Straight line (passes through origin (0, 0)) |
| | Does not pass through pole P₀ | Circle (satisfies condition C1) |
| Small circle | Passes through pole P₀ | Straight line (does not pass through origin (0, 0)) |
| | Does not pass through pole P₀ | Circle (does not satisfy condition C1) |

d²=r²−1 (10)

Therefore, the spherical perpendicular drawn from the point P to the boundary of the movable area on the sphere surface S is the following circle (B1) or straight line (B2) on the plane λ.

(B1) Circle that is orthogonal to the boundary of the movable area (satisfies the condition C1)
(B2) Straight line that is orthogonal to the boundary of the movable area (passes through the origin (0, 0))

The optimal solution of the point Pₘ can be determined depending on the shape of the movable area by utilizing the above property.

2-4-3. Optimal Solution when Utilizing Rectangular Restriction

A rectangular movable area (see FIG. 18) is set on the plane λ when utilizing rectangular restriction. A spherical perpendicular PP_{f} is drawn from the point P to one side (e.g., the side that corresponds to s=s₀) on the sphere surface S. The coordinates of a point f(P) are indicated by (sₚ, tₚ) (the point f(P) is a point obtained by projecting the point P onto the plane λ).

When tₚ≠0, calculating the spherical perpendicular PP_{f} corresponds to calculating a circle that satisfies the following conditions (D1) to (D3) on the plane λ.

(D1) Passes through the point f(P).
(D2) Be orthogonal to the straight line s=s₀.
(D3) Satisfies the expression (10).

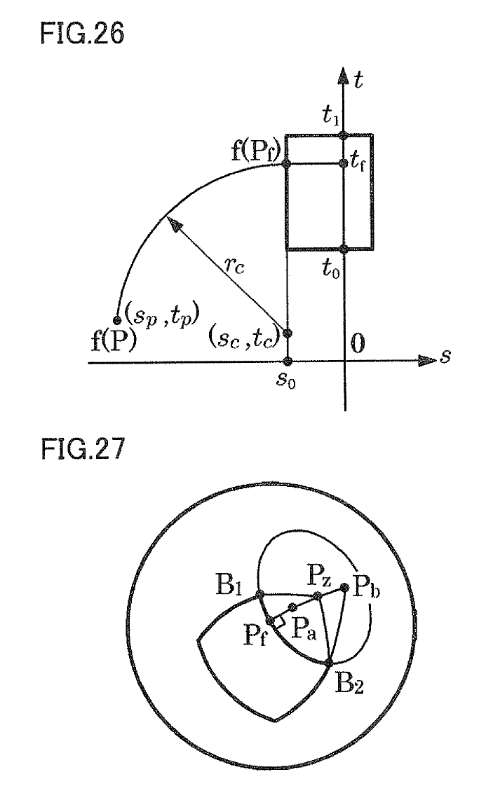

The coordinates (s_{c}, t_{c}) of the center of the circle and the radius r_{c} of the circle (see FIG. 26) are obtained by the following expression (11).

s_{c}=s₀

t_{c}=(sₚ²+tₚ²−2s₀sₚ−1)/(2tₚ)

r_{c}²=s₀²+t_{c}²+1 (11)

In FIG. 26, the point f(P_{f}) is the intersection point of the circle obtained by the expression (11) and the straight line s=s₀, and the coordinates of the point f(Pf) are indicated by (s_{f}, t_{f}) (s_{f}=s₀). If t₀≦t_{f}≦t₁ is satisfied, a spherical perpendicular has been drawn to the side (boundary) of the rectangular movable area. Note that the spherical perpendicular does not necessarily correspond to the shortest distance from the point P to the side (boundary) of the movable area, as illustrated in FIG. 27. In the example illustrated in FIG. 27, a spherical perpendicular PₐP_{f} drawn from a point Pₐ to a side B₁B₂ corresponds to the shortest distance from the point Pₐ to the side B₁B₂. However, the shortest distance from a point P_{b} to the side B₁B₂ corresponds to a great circle P_{b}B₂ instead of a spherical perpendicular P_{b}P_{f}.

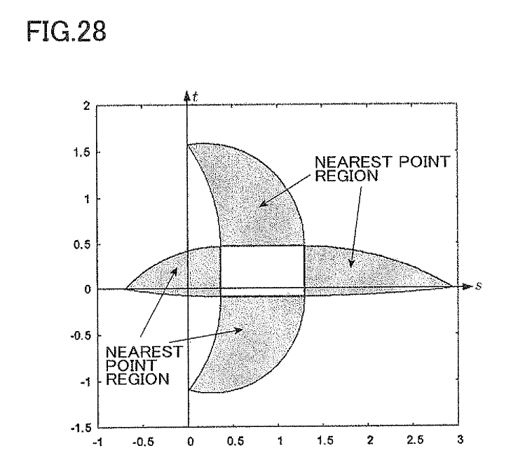

The center of the side B₁B₂ (small circle B₁B₂) on the sphere surface is referred to as point P_{z}. The spherical perpendicular drawn from the point P on the sphere surface to the side B₁B₂ corresponds to the shortest distance from the point P to the side B₁B₂ only when the point P is positioned within an area P_{z}B₁B₂. A spherical perpendicular can be reliably drawn from the point P to the side B₁B₂ when the point P is positioned within the area P_{z}B₁B₂. In this embodiment, the area P_{z}B₁B₂ is referred to as “nearest point region” of the side B₁B₂. FIG. 28 illustrates an example of the nearest point regions of the four sides of the movable area on the plane λ.

In FIG. 26, the t coordinate of the point f(P_{f}) is t_{f}=t_{c}±r_{c}. The double sign “±” is valid only when it is the same as the positive or negative of the value of tₚ. Otherwise the point f(P) is positioned outside the nearest point region. If t_{f} satisfies t₀≦t_{f}≦t₁, the point P_{f} is the optimal solution.

When tₚ is zero, projection (or its extension) of the spherical perpendicular PP_{f} onto the plane λ corresponds to a straight line that connects the point f(P) and the origin (0, 0). Therefore, a spherical perpendicular has been drawn when t₀≦0≦t₁ is satisfied. The point P is included within the nearest point region only when s₀−(s₀²+1)^{1/2}≦sₚ≦s₀ is satisfied. In this case, the foot (s_{f}=s₀, t_{f}=0) of the spherical perpendicular is the optimal solution. This determination expression can be rewritten as shown by the following expression (12).

sₚ(sₚ−2s₀)≦1

AND

sₚ≦s₀ (12)

When the side at s=s₁ is the target side, the following expression (13) is used instead of the above determination expression (expression (12)).

sₚ(sₚ−2s₁)≦1

AND

s_{P}≧s₁ (13)

When the point f(P) is not included within the nearest point regions corresponding to the four sides of the rectangular movable area, a spherical perpendicular cannot be drawn from the point P to the boundary of the movable area. In this case, the optimal solution Pₘ is one of the four vertices of the movable area. Therefore, the distance between the point P and each vertex of the movable area on the sphere surface S is calculated, and the vertex for which the calculated distance is a minimum is determined to be the optimal solution Pₘ.

2-4-4. Simple Solution when Utilizing Rectangular Restriction

A simple solution method described below may be used as the correction method when utilizing rectangular restriction. The simple solution method determines a point within the movable area for which the distance from the point f(P) on the plane λ is a minimum to be the solution. Let sₚ be the s coordinate of the point f(P) and sₘ be the s coordinate after correction. sₘ is obtained by the following expression (14). The t coordinate is obtained in the same manner.

sₘ=s₀(sₚ<s₀)

sₘ=sₚ(s₀≦sₚ≦s₁)

sₘ=s₁(s₁<sₚ) (14)

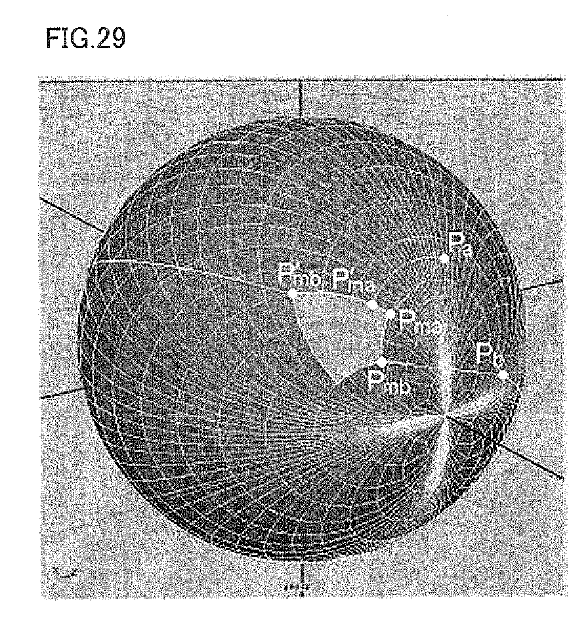

Note that the simple solution can be used as an approximate solution of the optimal solution only when the movable area is narrow (i.e., the absolute values of s₀, s₁, t₀, and t₁ are small) or the amount of correction is small. A problem occurs (see FIG. 29) when these conditions are not satisfied. In the example illustrated in FIG. 29, the optimal solution of the point Pₐ is a point Pₘₐ, and the simple solution is a point Pₘₐ′. The optimal solution of the point P_{b} is a point P_{mb}, and the simple solution is a point P_{mb}′ that is far away from the point P_{mb} over the sphere surface S.

### 2-4-5. Elliptical Restriction

When utilizing elliptical restriction, calculating the optimal solution corresponds to calculating a circle that is orthogonal to the boundary of the elliptical movable area on the plane λ. However, a high-degree equation is required to calculate the optimal solution, and cannot be algebraically solved.

The foot of a perpendicular line drawn to the boundary of the elliptical movable area on the plane λ may be employed as an approximate solution of the optimal solution. In this case, a solution can be algebraically obtained by solving a quartic equation. A solution (equation) can be obtained using mathematical software or the like. However, the resulting equation is very complex and is not practical. Note that a method that calculates a perpendicular line drawn to an ellipsoid is described in “John C. Hart, Distance to an Ellipsoid. Graphics Gems IV, pp. 113-119, Academic Press Inc., 1994”.

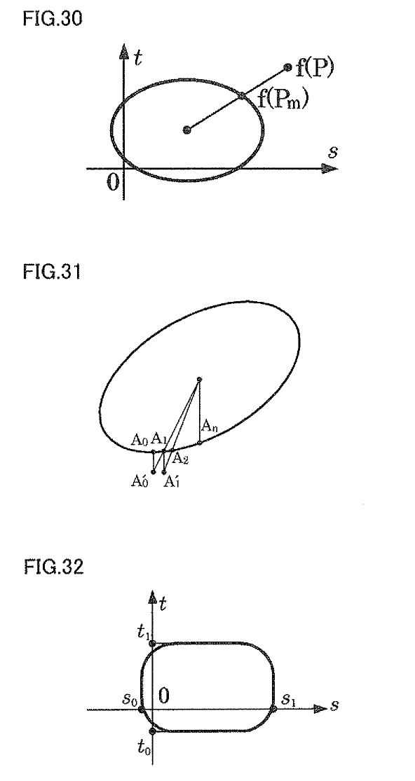

This embodiment employs a method that corrects the point f(P) toward the center of the ellipse to obtain a simple solution f(Pₘ) (see FIG. 30) although the simple solution f(Pₘ) is not accurate.

The coordinates (sₘ, tₘ) of the point f(Pₘ) can be easily calculated by the following expression (15). Note that sₐ, s_{b}, tₐ, and t_{b} are defined by the expression (8).

kₛ=(sₚ−s_{b})/sₐ

k₁=(tₚ−t_{b})/tₐ

kₘ=1/(kₛ²+k₁²)^{1/2}

sₘ=kₛkₘsₐ+s_{b}

tₘ=k₁kₘtₐ+t_{b} (15)

The simple solution when utilizing elliptical restriction obtained by the expression (15) is normally inaccurate. However, when s₀=−s₁=t₀=−t₁, since the movable area is a circle formed around the x-axis, the simple solution coincides with the optimal solution. Therefore, no problem occurs even if the simple solution is used when the movable area satisfies or almost satisfies the above condition.

On the other hand, a problem occurs in the following case when using the simple solution. FIG. 31 schematically illustrates the movable area of the joint in a three-dimensional space. An external force (e.g., gravity) is applied to the joint in the downward direction in FIG. 31. In this case, the joint should be positioned at a point A₀ (i.e., the lowest position). However, the joint is positioned at a point Aₙ when correcting the point using the simple solution. For example, even if the joint is positioned at the point A₀, the joint is moved to a point due to the external force, corrected to a simple solution repeatedly. Such as the joint is moved to a point A₀′ due to the external force and corrected to a simple solution A₁, and then moved to a point A₁′ due to the external force and corrected to a simple solution A₂. Finally the joint is settled at the point Aₙ.

### 2-4-6. Oval Restriction

An oval movable area (see FIG. 21) is set on the plane λ when utilizing oval restriction. The straight line that forms the boundary of the movable area is referred to as “side”, and the semicircle that forms the boundary of the movable area is referred to as “arc”. The straight line and the semicircle projected onto the sphere surface S are also referred to as “side” and “arc”, respectively. The coordinates of the center of the arc are indicated by (sₑ, tₑ), and the radius of the arc is indicated by rₑ. When sₐ≦tₐ (i.e., the movable area is vertically long on the plane λ), the following expression (16) is satisfied. In the expression (16), the two values for tₑ indicate the value of the lower arc and the value of the upper arc in this order.

rₑ=(s₁−s₀)/2=sₐ

sₑ=(s₁+s₀)/2=s_{b}

tₑ=t₀+rₑ,t₁−rₑ (16)

When sₐ≧tₐ (i.e., the movable area is horizontally long on the plane λ), the following expression (17) is satisfied. In the expression (17), the two values for sₑ indicate the value of the left arc and the value of the right arc in this order.

rₑ=(t₁−t₀)/2=tₐ

tₑ=(t₁+t₀)/2=t_{b}

sₑ=s₀+rₑ,s₁−rₑ (17)

The correction method when sₐ≦tₐ is described below. A spherical perpendicular PP_{f} is drawn from the point P to one side (boundary) of the movable area on the sphere surface S. This is the same as the case of drawing a spherical perpendicular to one side (boundary) of the movable area when utilizing rectangular restriction. Therefore, whether or not a spherical perpendicular can be drawn and whether or not the spherical perpendicular that has been drawn to the movable area corresponds to the shortest distance can be determined using the method used when utilizing rectangular restriction. When the optimal solution is not positioned on the two sides of the movable area, the foot P_{f} of a spherical perpendicular drawn to one arc of the movable area is the optimal solution. In this case, the point P_{f} is determined for each arc, and one of the points P_{f} for which the distance from the point P on the sphere surface S is a minimum is determined to be the optimal solution.

A method of calculating the foot of the spherical perpendicular when utilizing oval restriction is described below taking the lower arc of the movable area (sₐ≦tₐ) as an example. A great circle on the sphere surface S corresponds to a circle or a straight line on the plane λ, as described above.

A case where the spherical perpendicular PP_{f} corresponds to a circle on the plane λ is discussed below. Calculating the spherical perpendicular corresponds to calculating a circle that satisfies the following conditions (E1) to (E3) on the plane λ.

(E1) Passes through the point f(P).
(E2) Be orthogonal to the arc of the movable area.
(E3) Satisfies the expression (10).

Let (s_{c}, t_{c}) be the coordinates of the center of the circle. And let r_{c} be the radius of the circle. The coordinates (s_{f}, t_{f}) of the point f(P_{f}) can be calculated by the following process.

First, the coordinate values s_{c} and t_{c} are calculated by the following expression (18). Note that k₂=0 in the expression (18) only when the point f(P), the center (sₑ, tₑ) of the arc, and the origin (0, 0) are collinear (i.e., the spherical perpendicular PP_{f} corresponds to a straight line on the plane k). Therefore, k₂≠0 in this example.

k₀=sₚ²+tₚ²−1

k₁=sₑ²+tₑ²−1

k₂=2(sₑtₚ−sₚtₑ)

s_{c}=−(k₀tₑ−k₁tₚ)/k₂

t_{c}=(k₀sₑ−k₁sₚ)/k₂

The radius r_{c} is calculated by the following expression (19).

s_{g}=s_{c}−sₑ

t_{g}=t_{c}−tₑ

l_{g}=s_{g}²+t_{g}²

r_{c}=(l_{g}−rₑ²)^{1/2} (19)

A value k₄ is calculated by the following expression (20).

k₄=t_{g}r_{c}±s_{g}r_{c} (20)

k₄≦0 (21)

The coordinate values s_{f} and t_{f} obtained by the expression (22) are valid only when the value k₄ obtained by the expression (20) satisfies the expression (21). Specifically, since a spherical perpendicular is drawn to an extension of the arc (i.e., the inside of the movable area) instead of to the arc when k₄>0, the solution is invalid.

s_{f}=sₑ+(s_{g}rₑ±−t_{g}r_{c})rₑ/l_{g}

t_{f}=tₑ+k₄rₑ/l_{g} (22)

Note that the double signs in the expressions (20) and (22) are in the same order. Note also that the condition “k₄≦0” may be satisfied for both of the double sign in the expression (20) simultaneously. This means that two spherical perpendiculars can be drawn from the point P to one arc of the movable area. Specifically, while the arc of the movable area is a semicircle (center angle: 180°) on the plane λ, the center angle of the arc may exceed 180° on the sphere surface S (i.e., two spherical perpendiculars can be drawn).

A case of drawing the spherical perpendicular to the lower arc of the movable area has been described above. When drawing the spherical perpendicular to the upper arc of the movable area, the condition shown by the expression (21) is “k₄≧0”.

Second, a case where the spherical perpendicular PP_{f} corresponds to a straight line on the plane λ is discussed below. This is the case where k₂ in the expression (18) is zero. In this case, calculating the spherical perpendicular corresponds to calculating a straight line that satisfies the following conditions (F1) to (F3) on the plane λ.

(F1) Passes through the point f(P).
(F2) Be orthogonal to the arc of the movable area (i.e., passes through the point (sₑ, tₑ)).
(F3) Passes through the origin (0, 0).

In this case, the coordinates (s_{f}, t_{f}) of the optimal solution P_{f} can be obtained by the following expression (23). The double sign “±” is valid only when it is the same as the positive or negative of tᵢ for the upper arc or opposite to the positive or negative of tᵢ for the lower arc. Otherwise a spherical perpendicular is drawn to an extension of the arc (i.e., the inside of the movable area).

sₜ=sₚ−sₑ

tᵢ=tₚ−tₑ

k₅=(s₁²+tᵢ²)^{1/2}

s_{f}=sₑ±sᵢrₑ/k₅

t_{f}=tₑ±tᵢrₑ/k₅ (23)

A simple solution method described below may be used as the correction method when utilizing oval restriction. The simple solution method determines a point within the movable area for which the distance from the point f(P) on the plane λ is a minimum to be the solution.

The following description is given taking an example in which sₐ≧tₐ (i.e., the movable area is horizontally long).

The coordinates (sₑ₀, tₑ) of the center of the left arc (semicircle) of the boundary of the movable area, the coordinates (sₑ₁, tₑ) of the center of the right arc of the boundary of the movable area, and the radius rₑ are obtained by the following expression (24).

rₑ=(t₁−t₀)/2=tₐ

tₑ=(t₁+t₀)/2=t_{b}

sₑ₀=S₀+rₑ

sₑ₁=s₁−rₑ (24)

When the point f(P) (coordinates (sₚ, tₚ)) is positioned outside the movable area, the coordinates (sₘ, tₘ) after correction are obtained by the following expressions (25) to (27).

1) When sₚ<sₑ₀

k=rₑ/[(sₚ−sₑ₀)²+(tₚ−tₑ)²]^{1/2}

sₘ=k(sₚ−sₑ₀)+sₑ₀

tₘ=k(tₚ−tₑ)+tₑ (25)

2) When sₑ₀≦sₚ≦sₑ₁

Sₘ=Sₚ

When tₚ<t₀:tₘ=t₀

When tₚ>t₁:tₘ=t₁ (26)

3) When sₑ₁<sₚ

k=rₑ[(sₚ−sₑ₁)²+(tₚ−tₑ)²]^{1/2}

sₘ=k(sₚ−sₑ₁)+sₑ₁

tₘ=k(tₚ−tₑ)+tₑ (27)

When sₐ<tₐ, s and t are replaced by each other in the process performed when sₐ≧tₐ.

Note that the simple solution can be used as an approximate solution of the optimal solution only when the movable area is narrow (i.e., the absolute values of s₀, s₁, t₀, and t₁ are small) or the amount of correction is small for the same reason as in the case of utilizing rectangular restriction.

### 2-4-7. Super-Elliptical Restriction

When utilizing super-elliptical restriction, it is necessary to solve a high-degree equation in order to calculate the optimal solution in the same manner as in the case of utilizing elliptical restriction. A simple solution can be obtained by correcting the point toward the center of the super-elliptical movable area on the plane 2 in the same manner as in the case of utilizing elliptical restriction. Note that the simple solution does not coincide with the optimal solution even when s₀=−s₁=t₀=−t₁, differing from the case of utilizing elliptical restriction.

### 2-4-8. Restriction Using Combination of Arc and Straight Line

By using combination of arcs and a straight lines as illustrated in FIG. 32 instead of using super-ellipse to set the movable area, the optimal solution can be calculated by a correction method almost identical to that when utilizing oval restriction.

### 2-5. Twist Angle

### 2-5-1. Definition of Twist Angle

The bend state of the joint can be expressed by the position of the point P on the sphere surface S, as described above. On the other hand, the twist state of the joint is expressed by rotation around the axis OP (O is the center of the sphere surface S). It is necessary to define the direction of the twist angle 0° in a given bend state in advance in order to deal with the twist angle.

A state in which the directions of the coordinate axes (three axes) of the parent bone and the child bone coincide is defined as a standard state, and the twist angle in the standard state is defined as 0°. This is a state in which the twist angle is 0° when the point that indicates the bend state on the sphere surface S illustrated in FIG. 10 is positioned at the point P₁((1, 0, 0)).

In this embodiment, the term “simple rotation” is defined as follows.

Specifically, arbitrary unit vectors v₁ and v₂ that share the starting point are provided, and rotation that satisfies the following conditions (G1) and (G2) is defined as simple rotation from the unit vector v₁ to the unit vector v₂. Note that rotation does not occur when v₁=v₂ (unit matrix in rotation representation by matrix), and the rotation is undefined when v₁=−v₂.

(G1) Rotation around an axis perpendicular to a plane formed by the unit vectors v₁ and v₂.
(G2) The unit vector v₁ coincides with the unit vector v₂ as a result of rotation.

The state in which the twist angle is 0 in the bend state P is defined by applying the simple rotation from the axis OP₁ to the axis OP to the standard state. The directions of the y-axis and the z-axis of the child bone which has the twist angle 0 coincide to those of the grid illustrated in FIG. 11. Note that the direction of the twist angle 0° cannot be defined when P=P₀.

According to the above definition, a joint rotation matrix M shown by the following expression (28) can be decomposed into a bend matrix M_{b} and a twist matrix Mₜ, as shown by the following expressions (29) to (31). Note that the matrix type (e.g., multiplication order and element arrangement) is a type in which the column vector is multiplied.

$$\begin{matrix}M = ( \begin{matrix}{m}_{00} & {m}_{01} & {m}_{02} \\ {m}_{10} & {m}_{11} & {m}_{12} \\ {m}_{20} & {m}_{21} & {m}_{22}\end{matrix} ) & ( 28 ) \\ M = {M}_{b} {M}_{t} & ( 29 ) \\ {M}_{b} = ( \begin{matrix}{m}_{00} & - {m}_{10} & - {m}_{20} \\ {m}_{10} & {m}_{00} + {m}_{20}^{2} {d}_{0} & - {m}_{10} {m}_{20} {d}_{0} \\ {m}_{20} & - {m}_{10} {m}_{20} {d}_{0} & {m}_{00} + {m}_{10}^{2} {d}_{0}\end{matrix} ) & ( 30 ) \\ {M}_{t} = ( \begin{matrix}1 & 0 & 0 \\ 0 & ( {m}_{11} + {m}_{22} ) {d}_{0} & ( {m}_{12} - {m}_{21} ) {d}_{0} \\ 0 & ( {m}_{21} - {m}_{12} ) {d}_{0} & ( {m}_{11} + {m}_{22} ) {d}_{0}\end{matrix} ) & ( 31 )\end{matrix}$$

Note that d₀ in the expressions (30) and (31) is defined by the following expression (32). Note that d₀ may be defied to be “1/(m₀₀+1)”, However, it is preferable to use the following expression (32) in order to avoid cancellation when m₀₀ is approximately equal to −1 (i.e., P is approximately equal to P₀).

d₀=(1−m₀₀)/(m₁₀²+m₂₀²) (32)

### 2-5-2. Fixation of twist angle at 0°

A case where the twist angle of the joint is necessarily set to be 0° while correcting the bend state of the joint within the movable range is described below. The matrix M shown by the expression (28) indicates the rotational state of the joint, and a matrix obtained by correcting the rotational state within the movable range is referred to as M₁.

When the point on the sphere surface S that indicates the bend state is referred to as a point Pₘ the coordinates (x, y, z) of the point P are obtained by the following expression (33).

x=m₀₀

y=m₁₀

z=m₂₀ (33)

The point P is corrected within the movable area by the above-described method. Let a point Pₘ be the point on the sphere surface S that corresponds to the correction result and let (xₘ, yₘ, zₘ) be the coordinates of the point Pₘ. The matrix M₁ is obtained by the following expressions (34) and (35).

$${M}_{1} = ( \begin{matrix}{x}_{m} & - {y}_{m} & - {z}_{m} \\ {y}_{m} & {x}_{m} + {z}_{m}^{2} {d}_{1} & - {y}_{m} {z}_{m} {d}_{1} \\ {z}_{m} & - {y}_{m} {z}_{m} {d}_{1} & {x}_{m} + {y}_{m}^{2} {d}_{1}\end{matrix} ) \qquad ( 34 )$$

d₁=(1−xₘ)/(yₘ²+zₘ²) (35)

The matrix M₁ is expressed by the following expressions (36) and (37) using the st coordinates (sₘ, tₘ) of the point f(Pₘ).

$${M}_{1} = ( \begin{matrix}{d}_{2} - 1 & - {t}_{m} {d}_{2} & {s}_{m} {d}_{2} \\ {t}_{m} {d}_{2} & ( {s}_{m}^{2} + 1 ) {d}_{2} - 1 & {s}_{m} {t}_{m} {d}_{2} \\ - {s}_{m} {d}_{2} & {s}_{m} {t}_{m} {d}_{2} & ( {t}_{m}^{2} + 1 ) {d}_{2} - 1\end{matrix} ) \qquad ( 36 )$$

d₂=2/(sₘ²+tₘ²+1) (37)

Since the matrix M₁ can be directly calculated without calculating the coordinates (xₘ, yₘ, zₘ) corresponding to the point Pₘ after correcting the bend state on the plane λ by utilizing the expressions (36) and (37), the amount of calculations can be reduced.

### 2-5-3. Method of Setting Movable Range of Twist Angle

A case of correcting both the twist state and the bend state of the joint within the movable range is described below. The matrix M shown by the expression (28) indicates the rotational state of the joint, and a matrix obtained by correcting the rotational state within the movable range is referred to as M₂.

The matrix M can be decomposed into a bend matrix and a twist matrix, as shown by the expressions (29) to (31). The bend state is corrected using the expressions (33) to (35).

When the twist angle before correction is referred to as ψ, the twist angle ψ can be calculated from the following expression (38).

cos ψ=(m₁₁+m₂₂)d₀

sin ψ=(m₂₁−m₁₂)d₀ (38)

When the twist angle ψ is outside the movable range, the twist angle ψ is corrected to ψₘ. A twist matrix Mₜ₂ using ψₘ is shown by the following expression (39). The matrix M₂ is obtained by the following expression (40).

$${M}_{t2} = ( \begin{matrix}1 & 0 & 0 \\ 0 & cos {ψ}_{m} & - sin {ψ}_{m} \\ 0 & sin {ψ}_{m} & cos {ψ}_{m}\end{matrix} ) \qquad ( 39 )$$

M₂=m₁mₜ₂ (40)

### 2-6, Quaternion Representation

### 2-6-1. Decomposition into Bend and Twist

A case of expressing the rotation of the joint using a quaternion is discussed below. The quaternion can be decomposed into a bend quaternion and a twist quaternion in the same manner as in the case of using a matrix. A quaternion q that indicates the rotation of the joint is decomposed into a bend quaternion q_{b} and a twist quaternion qₜ (see below).

q=q_{b}qₜ (41)

When the quaternion q has elements (qₓ, q_{y}, q_{z}, q_{w}), the elements (q_{bx}, q_{by}, q_{bz}, q_{bw}) of the bend quaternion q_{b} are given as follows.

q_{bx}=0

q_{by}=(q_{y}q_{w}−qₓq_{z})/(qₓ²+q_{w}²)^{1/2}

q_{bz}=(qₓq_{y}+q_{z}q_{w})/(qₓ²+q_{w}²)^{1/2}

q_{bw}=(qₓ²+q_{w}²)^{1/2} (43)

The elements (qₜₓ, q_{ty}, q_{tz}, q_{tw}) of the twist quaternion qₜ are given as follows.

qₜₓ=qₓ/(qₓ²+q_{w}²)^{1/2}

q_{ty}=0

q_{tz}=0

q_{tw}=q_{w}/(qₓ²+q_{w}²)^{1/2} (43)

### 2-6-2. Bend/Twist Correction Method

When the point on the sphere surface S that indicates the bend state is referred to as a point P, the coordinates (x, y, z) of the point P are obtained by the following expression (44).

x=2(qₓ²+q_{w}²)−1

y=2(qₓq_{y}+q_{z}q_{w})

z=2(qₓq_{z}−q_{y}q_{w}) (44)

The point P is corrected to a point within the movable area by the above-described method. Let a point Pₘ be the point on the sphere surface S that corresponds to the correction result and let (xₘ, yₘ, zₘ) be the coordinates of the point Pₘ. The bend quaternion q₁=(q₁ₓ, q_{1y}, q_{1z}, q_{1w}) after correction is obtained by the following expression (45).

q₁ₓ=0

q_{1y}=−zₘ/[2(1+xₘ)]^{1/2}

q_{1z}=yₘ/[2(1+xₘ)]^{1/2}

q_{1w}=[(1+xₘ)/2]^{1/2} (45)

The bend quaternion qᵢ is shown by the following expressions (46) and (47) using the coordinates (s, t) of the point f(P) instead of the coordinates (x, y, z) of the point P.

s=(q_{y}q_{w}−qₓq_{z})/(qₓ²+q_{w}²)

t=(qₓq_{y}+q_{z}q_{w})/(qₓ²+q_{w}²) (46)

q₁ₓ=0

q_{1y}=sₘ/(sₘ²+tₘ²+1)^{1/2}

q_{1z}=tₘ/(sₘ²+tₘ²+1)^{1/2}

q_{1w}=1/(sₘ²+tₘ²+1)^{1/2} (47)

When the twist angle before correction is referred to as ψ, the twist angle ψ can be calculated from the following expression (48).

cos(ψ/2)=q_{w}/(qₓ²+q_{w}²)^{1/2}

sin(ψ/2)=qₓ/(qₓ²+q_{w}²)^{1/2} (48)

When the twist angle ψ is outside the movable range, the twist angle ψ is corrected to ψₘ. A twist quaternion q₂=(q₂ₓ, q_{2y}, q_{2z}, q_{2w}) using ψₘ is shown by the following expression (49).

q₂x=sin(ψₘ/2)

q_{2y}=0

q_{2z}=0

q_{2w}=cos(ψₘ/2) (49)

A quaternion q₃ after correcting the bend state and the twist state is obtained by the following expression (50).

q₃=q₁q₂ (50)

### 2-6-3. Bend Angle Restriction Using Quaternion

Since the quaternion shown by the expression (42) indicates the bend state of the joint, the bend angle may be restricted by setting the movable range for the elements q_{by} and q_{bz}. However, this method poses the following problem as compared with the projection method.

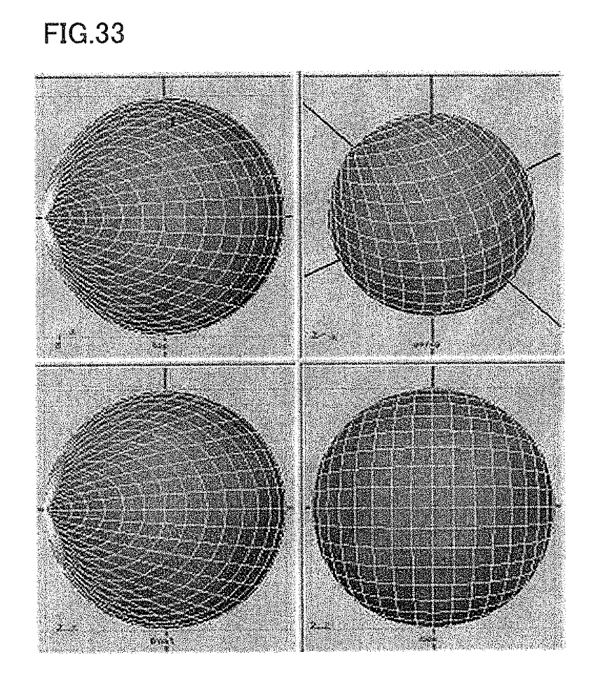

A grid illustrated in FIG. 33 is obtained by creating a grid (grid line) on the sphere surface S while changing the values η and ζ in q_{by}=sin(η/2) and q_{by}=sin(ζ/2) from −180° to 180° at intervals of 10°. Note that q_{by}²+q_{bz}²≦1.

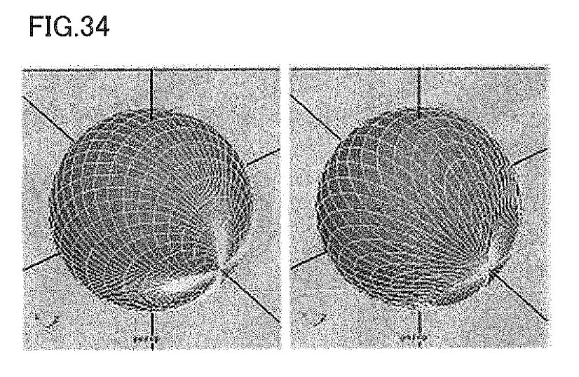

When comparing the case of employing the quaternion (FIG. 33) with the case of employing the projection method (FIG. 11), a similar shape is obtained for the small bend angle. However, while an orthogonal grid is obtained by the projection method, a non-orthogonal grid is obtained by angle restriction using the elements q_{by} and q_{bz}. In particular, the grid crossing angle significantly differs from a right angle in the pole-side hemisphere when employing angle restriction using the quaternion (q_{by}, q_{bz}) (see FIG. 34). This is not suitable for setting the movable area. However, when setting a circular movable area that is symmetrical with respect to the x-axis, the movable area can be accurately set by restricting the sum of squares of the elements q_{by} and q_{bz}.

### 2-7. Collision Repulsion at Boundary of Movable Area

In the above description, when the bend state of the joint exceeds the movable area, the bend state of the joint is corrected to the boundary of the movable area. A method that implements a repulsion (rebound) behavior upon collision against the boundary of the movable area is described below.

The bend state of the joint is expressed by the position of the point P on the sphere surface S. When the bend state of the joint has changed, the point P moves on the sphere surface S so that the point f(P) moves on the plane λ. This embodiment employs a method that approximates the movement of the point f(P) within the step time to a uniform linear motion when calculating the bend state of the joint on the assumption that the step time is sufficiently short (e.g., 1/60th of a second).

Since the projection f is conformal mapping, the incident angle and the reflection angle on the sphere surface S are maintained on the plane λ. Therefore, a repulsion behavior on the plane λ, can be calculated by a normal method.

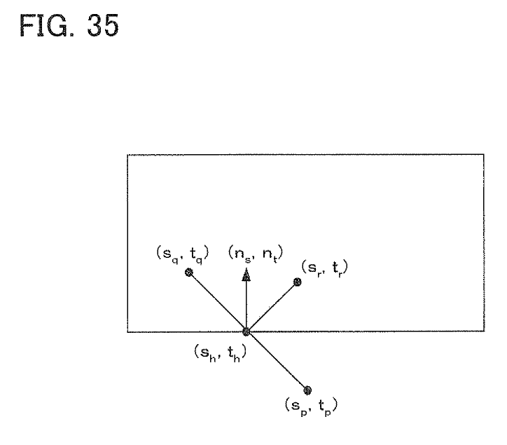

As illustrated in FIG. 35, the position of the point f(P) on the plane λ, outside the movable area is indicated by (sₚ, tₚ), the position of the point f(P) on the plane λ, within the movable area at one step time before is indicated by (s_{q}, t_{q}), the collision position on the plane λ, at the boundary of the movable area is indicated by (sₕ, tₕ), the position on the plane λ after repulsion is indicated by (sᵣ, tᵣ), and the normal direction of the boundary at the collision position on the plane k is indicated by (nₛ, nₜ).

### 2-7-1. Speed/Acceleration Conversion Expression

A speed/acceleration conversion expression between on the sphere surface S and on the plane λ is determined. A first-order derivative with respect to time is indicated by a single quotation mark (′), and a second-order derivative with respect to time is indicated by a double quotation mark (″). Differentiating the expression (1) with respect to time gives the following expressions (51) and (52). The speed and the acceleration of the point f(P) on the plane λ can be calculated from the speed and the acceleration of the point P on the sphere surface S using the expressions (51) and (52).

s′=(−z′−sx′)/(x+1)

t′=(y′−tx′)/(x+1) (51)

s″=(−z″−sx″−2s′x′)/(x+1)

t″=(y″−tx″−2t′x′)/(x+1) (52)

Differentiating the expression (2) with respect to time gives the following expression (53). The speed of the point P on the sphere surface S can be calculated from the speed of the point f(P) on the plane λ using the expression (53).

x′=(x+1)(zs′−yt′)

y′=x′t+(x+1)t′

z′=x′s−(x+1)s′ (53)

### 2-7-2. Collision Repulsion on Plane λ

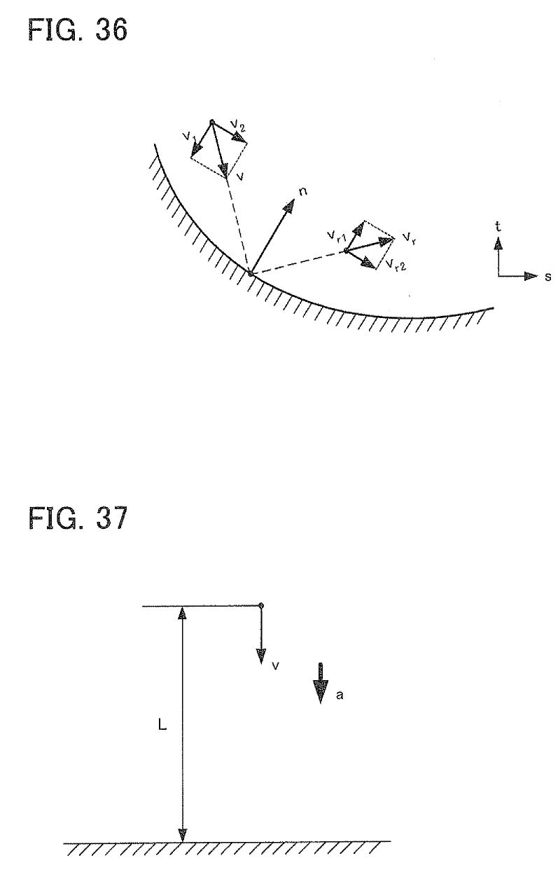

A repulsion behavior on the plane λ upon collision against the boundary of the movable area is calculated. As illustrated in FIG. 36, the velocity vector before collision is indicated by v, the velocity vector after collision is indicated by v and the boundary normal vector at the collision position is indicated by n. Note that |n|=1. The coefficient of restitution for the collision is indicated by e, and the coefficient of friction is indicated by μ. Note that 0≦e≦1 and 0≦μ.

The normal component vector v₁ and the tangential component vector v₂ of the velocity vector v before collision are obtained by the following expression (54).

v₁=(v·n)n

v₂=v−v₁ (54)

The normal component vector vᵣ₁ and the tangential component vector vᵣ₂ of the velocity vector vᵣ after collision are obtained by the following expression (55). In the expression (55), vᵣ₂=0 when |vᵣ₂| is a negative value.

vᵣ₂=−ev₁

|vᵣ₂|=|v₂|+μ(1+e)(v·n)

v₅₂=(|vᵣ₂/|v₂|)v₂

vᵣ=vᵣ₁+vᵣ₂

### 2-7-3. Convergence of Repetitive Repulsion

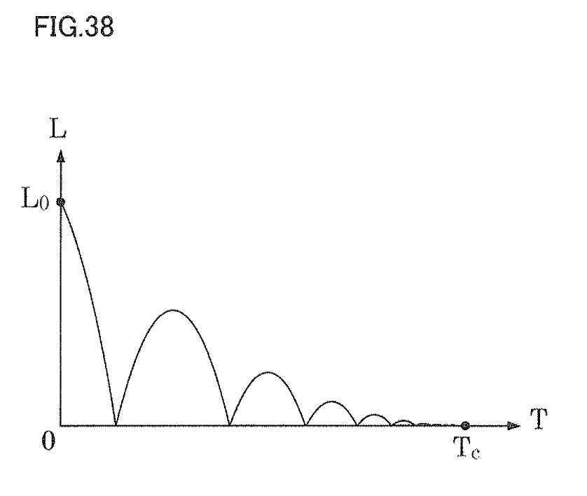

When collision repulsion occurs at a constant acceleration a (see FIG. 37), the distance L normally changes as illustrated in FIG. 38 with the passage of time T. The repulsion cycle is a geometrical progression of which the common ratio is the coefficient of restitution e, and the reputation converges to zero within a finite time.

On the other hand, the speed is set to be constant during one step time when calculating collision repulsion. Therefore, when the repulsion cycle is equal to or shorter than the step time, the repulsion behavior cannot be correctly handled. In this embodiment, repetitive repulsion is caused to converge using the following method.

The initial values of the speed v and the distance L are indicated by v₀ and L₀, respectively. The time required for convergence is an infinite geometrical series (i.e., the sum of infinite geometrical progression), and indicated by the following expression (56). If the time T_{c} obtained by the expression (56) is equal to or less than a given value (e.g., a value several to several tens of times the step time), the speed v and the distance L are set to be zero.

kₑ=(1+e)/(1−e)

T_{c}=[−v₀kₑ(v₀²+2aL₀)^{1/2}]/a (56)

2-7-4. Repulsion Behavior when Utilizing Rectangular Restriction

A parameter τ that indicates time is introduced to calculate the collision time.

The step time starts at τ=0, and the step time ends at τ=1.

In other words, the position of the point f(P) at τ=0 is the point (s_{q}, t_{q}) within the movable area at one step time before, and the position of the point f(P) at Σ=1 when disregarding collision is the point (sₚ, tₚ) outside the movable area.

The parameter τ is also used when utilizing another restriction (elliptical restriction or oval restriction).

First, the value τₛ is separately calculated for the following three cases depending on the value sₚ of the position (sₚ, tₚ) of the point f(P) outside the movable area.

1) When sₚ<s₀

τₛ=(s₀−s_{q})/(sₚ−s_{q}) (57)

2) When s₀≦sₚ≦s₁

τₛ= (58)

3) When s₁<sₚ

τₛ=(s₁−s_{q})/(sₚ−s_{q}) (59)

Second, The value τₜ is separately calculated for the following three cases depending on the value tₚ of the position (sₚ, tₚ) of the point f(P) outside the movable area.

1) When tₚ<t₀

τₜ=(t₀−t_{q})/(tₚ−t_{q}) (60)

2) When t₀≦tₚ≦t₁

τₜ=2 (61)

3) When t₁<tₚ

τₜ=(t₁−t_{q})/(tₚ−t_{q}) (62)

The right side of the expressions (58) and (61) is a value larger than “1” (“2” is used in this example). In this embodiment, the value τₛ calculated by the expressions (57) to (59) is compared with the value τₜ calculated by the expressions (60) to (62), and the smaller of the values τₛ and τₜ is determined to the parameter τ.

τ=min(τₛ,τₜ) (63)

The parameter t shown by the expression (63) indicates the collision time.

And then, The collision position (sₕ, tₕ) on the boundary of the movable area can be obtained by the following expression (64).

sₕ=τ(sₚ−s_{q})+s_{q}

tₕ=τ(tₚ−t_{q})+t_{q} (64)

The normal (nₛ, nₜ) of the boundary of the movable area at the collision position is as follows.

1) When τₛ≧τₜ

When tₚ<t₀:nₛ=0,nₜ=1

When tₚ>t₁:nₛ=0,nₜ=−1 (65)

2) When τₛ<τₜ

When sₚ<s₀:nₛ=1,nₜ=0

When sₚ>s₁:nₛ=−1,nₜ=0 (66)

Lastly, The repulsion behavior due to collision is calculated by the method described in the section entitled “2-7-2. Collision repulsion on plane λ,” using the vector (sₚ−s_{q}, tₚ−t_{q}) as the velocity vector before collision. Let (vᵣₛ, vᵣₜ) be the velocity vector after collision. The position after repulsion is obtained by the following expression (67).

sᵣ=sₕ+(1−τ)vᵣₛ

tᵣ=tₕ+(1−τ)vᵣₜ (67)

2-7-5. Repulsion Behavior when Utilizing Elliptical Restriction

The coordinates of the collision position when utilizing elliptical restriction are indicated by the solution (s, t) of the following simultaneous equations (refer to the expression (8) for sₐ, s_{b}, tₐ, and t_{b}).

[(s−s_{b})/sₐ]²+[(t−t_{b})/tₐ]²=1

(s−s_{q})(tₚ−t_{q})=(t−t_{q})(sₚ−s_{q}) (68)

Transforming s and t using the parameter τ gives the following quadratic equation for the parameter τ.

s=τ(sₚ−s_{q})+s_{q}

t=τ(tₚ−t_{q})+t_{q}

k₁τ²−2k₂τ+k₃=0 (69)

where, the coefficients k₁, k₂, and k₃ are defined as follows.

k₁=sₐ²(tₚ−t_{q})²+tₐ²(sₚ−s_{q})²

k₂=sₐ²(tₚ−t_{q})(t_{b}−t_{q})+tₐ²(sₚ−s_{q})(s_{b}−s_{q})

k₃=sₐ²(t_{b}−t_{q})²+tₐ²(s_{b}−s_{q})²−sₐ²tₐ² (70)

The solution of the parameter τ (i.e., collision time) is obtained as follows.

D=k₂²−k₁k₃

When k₂≧0:τ=r=(k₂+D^{1/2}/k₁

When k₂<0:τ=k₃/(k₂−D^{1/2}) (71)

In the expression (71), classification using the value k₂ is used to prevent a deterioration in accuracy due to cancellation.

The collision position (sₕ, tₕ) of the boundary of the movable area is obtained by the following expression (72).

sₕ=τ(Sₚ−S_{q}+S_{q}

tₕ=τ(t_{P}−t_{q})+t_{q} (72)

The normal (nₛ, nₜ) of the boundary of the movable area at the collision position is as follows.

nₛ=(s_{b}−sₕ)tₐ²

nₜ=(tₕ−tₕ)sₐ² (73)

The repulsion behavior due to collision is calculated by the method described in the section entitled “2-7-2. Collision repulsion on plane λ” using the vector (sₚ−s_{q}, tₚ−t_{q}) as the velocity vector before collision. Let (vᵣₛ, vᵣₜ) be the velocity vector after collision. The position after repulsion is obtained by the following expression (74).

sᵣ=sₕ+(1−t)vᵣₛ

tᵣ=tₕ+(1−τ)vᵣₜ (74)

2-7-6. Repulsion Behavior when Utilizing Oval Restriction

The following description is given taking an example in which sₐ≧tₐ (i.e., the movable area is horizontally long). The coordinates of the center of the left arc (semicircle) of the boundary of the movable area are indicated by (sₑ₀, tₑ), the coordinates of the center of the right arc of the boundary of the movable area are indicated by (sₑ₁, tₑ), and the radius is indicated by rₑ.

### Determination of Collision Against Side of Boundary of Movable Area:

First, whether or not collision against the side (straight line) of the boundary of the movable area occurs is determined. The following three cases are considered depending on the value tₚ.

1) When tₚ<t₀

τ=(t₀−t_{q})/(tₚ−t_{q})

sₕ=τ(sₚ−s_{q} (75)

When sₑ₀≦sₕ≦sₑ₁ in the expression (75), since collision against the lower side occurs, the parameter τ is determined to be the solution, and collision detection against the arc of the boundary of the movable area is omitted. Otherwise, collision detection against the arc of the boundary of the movable area follows, because the solution is invalid.

2) When t₁<tₚ

τ=(t₁−t_{q})/(tₚ−t_{q})

sₕ=τ(sₚ−s_{q})+s_{q} (76)

When sₑ₀≦sₕ≦sₑ₁ in the expression (76), since collision against the upper side occurs, the parameter τ is determined to be the solution, and collision detection against the arc of the boundary of the movable area is omitted. Otherwise collision detection against the arc of the boundary of the movable area follows, because the solution is invalid.

3) When t₀≦tₚ≦t₁

In this case, since collision against the side of the boundary of the movable area does not occur, collision detection against the arc of the boundary of the movable area follows.

### Collision Detection Against Arc of Boundary of Movable Area:

Second, when the solution of the parameter τ has not yet been determined, collision detection against the arc of the boundary of the movable area follows. Whether or not collision against the left arc occurs is determined. The coordinates of the collision position are indicated by the solution (s, t) of the following simultaneous equations.

(s−sₑ₀)²+(t−tₑ)²=rₑ²

(s−s_{q}(tₚ−t_{q})=(t−t_{q})(sₚ−s_{q}) (77)

Transforming s and t in the expression (77) using the parameter τ gives the following quadratic equation for the parameter τ.

s=τ(sₚ−s_{q})+s_{q}

t=τ(tₚ−t_{q})+t_{q}

k₁τ²−2k₂τ+k₃=0 (78)

where, the coefficients k₁, k₂, and k₃ are defined as follows.

k₁=(sₚ−s_{q})²+(tₚ+t_{q})²

k₂=(sₚ−s_{q})(sₑ₀−s_{q})+(tₚ−t_{q})(tₑ−t_{q})

k₃=(sₑ₀−s_{q})²+(tₑ−t_{q})²−rₑ² (79)

When the discriminant D=k₂²−k₁k₃ regarding the coefficients k₁, k₂, and k₃ yields a negative value, collision against the left arc does not occur. When D≧0, the parameter τ can be calculated by the following expression (80).

When k₂≧0:τ=(k₂+D^{1/2})/k₁

When k₂<0:τ=k₃/(k₂−D^{1/2}) (80)

In the expression (80), classification using the value k₂ is used to prevent a deterioration in accuracy due to cancellation. When τ≧0 and sₕ=τ(sₚ−s₁)+s_{q}≦sₑ₀, since collision against the left arc occurs, the parameter τ is determined to be the solution, and the subsequent determination is omitted. Otherwise the solution is discarded.

When the solution of the parameter τ has not yet been determined as a result of the above calculations, collision against the right arc of the boundary of the movable area necessarily occurs. In this case, the parameter τ is calculated in the same manner as for the left arc using sₑ₁ instead of sₑ₀.

And then, the collision position (sₕ, tₕ) at the boundary of the movable area can be obtained by the following expression (81).

sₕ=τ(sₚ−s_{q})+s_{q}

tₕ=τ(tₚ−t_{q})+t_{q} (81)

The normal (nₛ, nₜ) of the boundary of the movable area at the collision position is as follows.

Collision against lower side: nₛ=0,nₜ=1

Collision against upper side: nₛ=0,nₜ=±1

Collision against left arc: nₛ=sₑ₀−sₕ,nₜ=tₑ−tₕ

Collision against right arc: nₛ=sₑ₁−sₕ,nₜ=tₑ−tₕ (82)

Lastly, The repulsion behavior due to collision is calculated by the method described in the section entitled “2-7-2. Collision repulsion on plane λ,” using the vector (sₚ−s_{q}, tₚ−t_{q}) as the velocity vector before collision. Let (vᵣₛ, vᵣₜ) be the velocity vector after collision. The position after repulsion is obtained by the following expression (83).

sᵣ=sₕ+(1−τ)vᵣₛ

tᵣ=tₕ+(1−τ)vᵣₜ (83)

When setₐ<tₐ, s and t are replaced by each other in the process performed when sₐ≧tₐ.

### 2-7-7. Repetitive Collisions

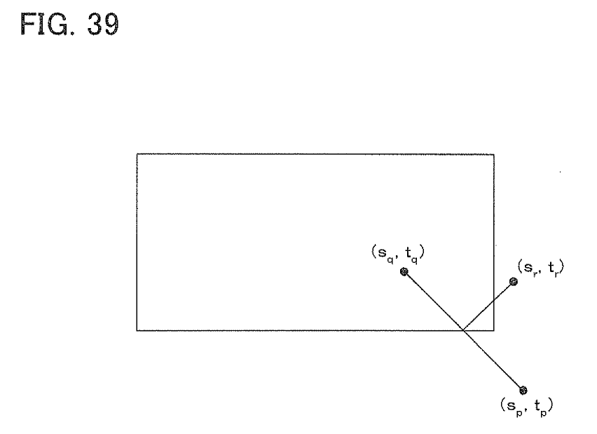

The result (Sᵣ, tᵣ) obtained by the above collision repulsion calculations may be positioned outside the movable area (see FIG. 39). In this case, the following two methods may be employed.

1) Perform repulsion calculations again.
2) Return the point to the boundary using the method described in the section entitled “2-4. Correction method when movable area is exceeded”.

When performing repulsion calculations again, the result may also be positioned outside the movable area. In this case, it is preferable to terminate the repulsion calculations and return the point to the boundary using the method described in the section entitled “2-4. Correction method when movable area is exceeded”.

### 2-8. Effects Achieved by Method According to this Embodiment

According to the projection method according to this embodiment, since transformation and inverse transformation utilizing projection involve only four arithmetic operations, the calculation load can be reduced.

The optimal solution can be calculated by practical calculations using the correction process (rectangular restriction or oval restriction) of the projection method according to this embodiment.

Since the correction process (rectangular restriction or oval restriction) of the projection method according to this embodiment involves only four arithmetic operations except for a few square root calculations, the calculation load can be reduced. Therefore, the speed of calculations can be increased using a vector arithmetic unit (or SIMD).

Since the projection method according to this embodiment calculates the three-dimensional repulsion behavior of the joint using the repulsion behavior on the plane, the repulsion behavior can be simply calculated.

When setting the movable area using the projection method according to this embodiment, the movable area can be set corresponding to each joint. The method of restricting the movable area may differ depending on each joint. For example, the movable area can be set corresponding to the motion of each joint, such as setting the movable area of one joint by utilizing rectangular restriction, and setting the movable area of another joint by utilizing oval restriction.

When a calculation result such that the direction of the child bone exceeds the movable area is obtained, a joint for which the direction of the child bone is corrected to the boundary of the movable area, and a joint for which the direction of the child bone is calculated to indicate the repulsion behavior at the boundary of the movable area may be provided.

The method of restricting the movable area of the joint and the measures taken when a calculation result such that the direction of the child bone exceeds the movable area is obtained may be set corresponding to the type of character (e.g., human, robot, or animal).

### 3. Process According to this Embodiment

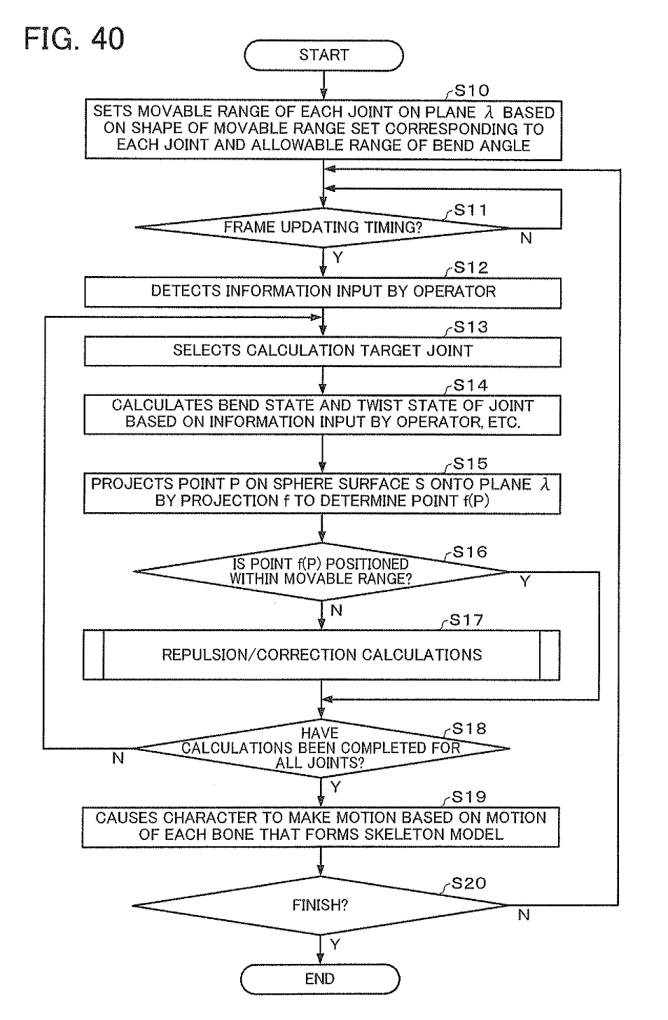

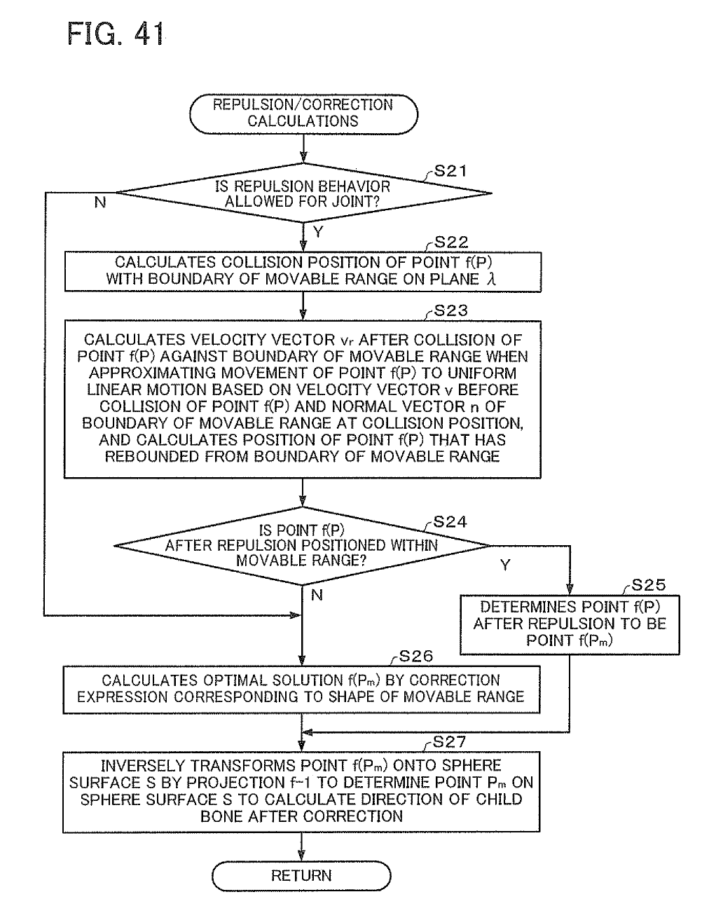

An example of a process that implements the method according to this embodiment is described below using flowcharts illustrated in FIGS. 40 and 41. The following description illustrates a case of applying the method according to this embodiment to a game program.

First, As an initial setting, the movable range of each joint that forms the skeleton model is set on the plane λ based on the shape of the movable area set in advance corresponding to each joint and the allowable range of the bend angle (step S10).

And, when the frame update timing (e.g., when 1/60th of a second has elapsed from the preceding frame) has been reached (Y in step S11), information input by the operator is detected (step S12).

Second, the calculation target joint is selected from a plurality of joints included in the skeleton model of the character operated by the operator (step S13), and the bend state and the twist state of the calculation target joint are calculated based on the information input by the operator, the external force information based on a hit between the objects, and the motion-affecting information (step S14).

And then, the point P that is positioned on the sphere surface S and indicates the direction of the child bone with respect to the parent bone that is linked to the child bone via the calculation target joint is projected onto the plane λ by the projection f to determine the point f(P) (a center point of the sphere is the joint) (step S15), and whether or not the point f(P) on the plane λ, is positioned within the movable range is determined (step S16).

And then, when the point f(P) is positioned outside the movable range (N in step S16), repulsion/correction calculations are performed to return the point f(P) to a position within the movable range (step S17).

The repulsion/correction calculations are performed according to the flowchart illustrated in FIG. 41.

First, whether or not the calculation target joint is a joint for which repulsion behavior at the boundary of the movable range is allowed is determined (step S21).

When it has been determined that the calculation target joint is a joint for which repulsion behavior is allowed (Y in step S21), the collision position of the point f(P) with the boundary of the movable range on the plane λ is calculated (step S22). Then, the velocity vector vᵣ after collision when approximating the movement of the point f(P) to a uniform linear motion is calculated based on the velocity vector v before the point f(P) collides against the boundary of the movable range and the normal vector n of the boundary of the movable range at the collision position, and the position of the point f(P) that has rebounded from the boundary of the movable range is calculated (step S23).

Second, whether or not the point f(P) after repulsion is positioned within the movable range is determined (step S24). When the point f(P) after repulsion is positioned within the movable range (Y in step S24), the point f(P) after repulsion is determined to be the point f(Pₘ) (step S25), and the point f(Pₘ) is inversely transformed onto the sphere surface S by the projection f⁻¹ to determine the point Pₘ on the sphere surface S to calculate the direction of the child bone after correction (step S27).

And, when the point f(P) after repulsion is not positioned within the movable range (N in step S24), the optimal solution f(Pₘ) is calculated by the correction expression corresponding to the shape of the movable area of the calculation target joint in order to correct the point f(P) to a position on the boundary of the movable range (step S26).

And then, the point f(Pₘ) is then inversely transformed onto the sphere surface S by the projection f⁻¹ to determine the point P on the sphere surface S so as to calculate the direction of the child bone after correction (step S27). In this embodiment, the processes in the steps S26 and S27 are also performed when it has been determined that the calculation target joint is not a joint for which repulsion behavior is not allowed (N in step S21).

And then, when the calculations have been completed for all of the joints that form the skeleton model (Y in step S18), the character operated by the operator is caused to make a motion based on the motion (change in direction) of each bone that forms the skeleton model (step S19).

In the example illustrated in FIG. 40, the processes in the steps S11 to S19 are repeated until the game ends. When the game ends (Y in step S20), the process is terminated.

### 4. Hardware Configuration Example

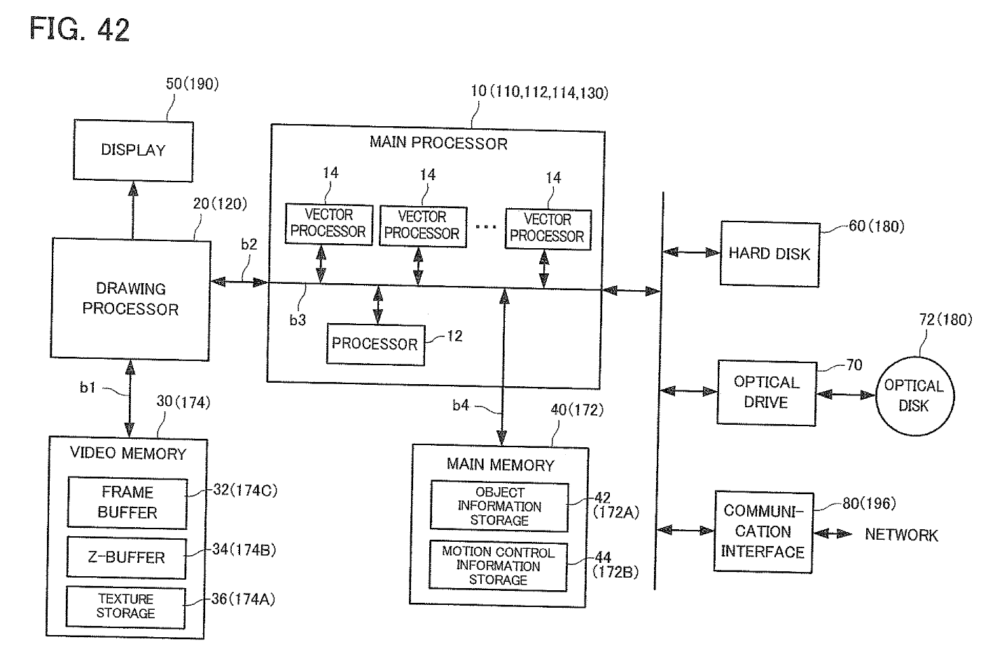

An example of a hardware configuration that implements the skeleton motion control device according to one embodiment of the invention is described below with reference to FIG. 42. Note that FIG. 42 illustrates only the main configuration. Hardware (e.g., memory controller or speaker) not illustrated in FIG. 42 may also be provided, if necessary.

A main processor 10 operates based on a program stored in an optical disk 72 (information storage medium such as CD, DVD, or Blu-ray Disc), a program transferred via a communication interface 80, a program stored in a hard disk 60, and the like, and performs various processes (e.g., game process, image process, and sound process) using a main memory 40 that is accessible via an internal bus b4 as a work area.

The main processor 10 includes one processor 12 and a plurality of vector processors 14. The processor 12 performs various processes (e.g., execution of an OS, hardware resource management, the game process, and management of the operation of the vector processors 14). The vector processor 14 is a vector operation-specific processor, and mainly performs a geometric process, image data/sound data codec process, and the like.

A drawing processor 20 can access a video memory 30 via an internal bus b1 The drawing processor 20 can also access the main memory 40 via an internal bus b2 that connects the drawing processor 20 with the main processor 10, an internal bus b3 provided in the main processor 10, and the internal bus b4 that connects the main processor 10 with the main memory 40. Specifically, the skeleton motion control device according to this embodiment is configured so that the drawing processor 20 utilizes the video memory 30 as a basic rendering target and can optionally utilize the main memory 40 as an exceptional rendering target.

The drawing processor 20 performs a geometric process (e.g., coordinate transformation, perspective transformation, light source calculations, and curved surface generation). The drawing processor 20 includes a product sum calculator and a divider that can perform high-speed parallel calculations, and performs matrix calculations (vector calculations) at high speed. For example, when performing a coordinate transformation, a perspective transformation, or light source calculations, a program that operates on the main processor 10 issues instructions to the drawing processor 20.

The drawing processor 20 also performs a drawing (rendering) process on an image of an object (i.e., an object formed by a primitive surface such as a polygon or a curved surface) subjected to the geometric process at high speed. When performing a multipath rendering process, the drawing processor 20 renders an image in a frame buffer 32 of the video memory 30 while performing a hidden surface removal process using a Z-buffer 34 and a texture mapping process using a texture storage section 36 based on drawing information (vertex information and other parameters) and the like. The drawing processor 20 may perform a filtering process (e.g., glare filtering process, motion blur process, depth of field process, and fog process) as the multipath rendering process. When the image has been rendered in the frame buffer 32 provided in the video memory 30 via the final rendering path, the image is output to a display 50.

The hard disk 60 stores a system program, save data, personal data, and the like.

An optical drive 70 drives an optical disc 72 (information storage medium) that stores a program, image data, sound data, and the like to enable access to the program and the data.

The communication interface 80 is an interface for transferring data with the outside via a network. In this case, the network connected to the communication interface 80 may be a communication channel (analog telephone line or ISDN), a high-speed serial bus, or the like. Data transfer via the Internet can be implemented by utilizing a communication channel. Data transfer with another skeleton motion control device can be implemented by utilizing a high-speed serial bus.

In the skeleton motion control device (computer) according to this embodiment, a program that causes the main processor 10 to perform a coordinate transformation, a movable range setting process, and skeleton motion calculations is stored in the optical disk 72 (i.e., information storage medium) or the hard disk 60 (i.e., information storage medium).

Each section (each means) according to this embodiment may be implemented by only hardware, or may be implemented by only a program stored in the information storage medium or a program distributed through the communication interface. Alternatively, each section according to this embodiment may be implemented by hardware and a program.

When implementing each section according to this embodiment by hardware and a program, a program that causes the hardware (computer) to function as each section according to this embodiment is stored in the information storage medium. Specifically, the above program instructs the processors 10 and 20 (hardware) to perform a process, and transfers data to the processors 10 and 20, if necessary. The processors 10 and 20 implement each section according to this embodiment based on the instructions and the data.

Note that the invention is not limited to the above embodiments. Various modifications and variations may be made. For example, any term cited with a different term having a broader meaning or the same meaning at least once in the specification and the drawings may be replaced by the different term in any place in the specification and the drawings. The method of causing the skeleton model to make a motion is not limited to the method described in the above embodiments. A method equivalent to the above method is also included within the scope of the invention.

The invention may be applied to various games (e.g., fighting game, shooting game, robot fighting game, sport game, competitive game, role-playing game, music performance game, and dance game). The invention may be applied to various game systems such as an arcade game system, a consumer game system, a large-scale attraction system in which a number of operators participate, a simulator, a multimedia terminal, a system board that generates a game image, and a portable telephone.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A computer-readable information storage medium storing a program that controls a motion of a skeleton model in which a parent bone and a child bone are linked via a joint, the program causing a computer to function as:
a movable range setting section that sets a movable range of the joint on a projection plane, the projection plane being a plane that is orthogonal to an axis that connects a center point of a sphere and a focus that is a given point on the sphere surface, the center point of the sphere being the joint;
a coordinate transformation section that projects a point on the sphere surface onto the projection plane based on the focus, the point indicates a direction of the child bone; and
a skeleton motion calculation section that calculates the direction of the child bone with respect to the parent bone within the movable range based on a position of the point projected onto the projection plane.

2. The information storage medium as defined in claim 1,
wherein the movable range setting section sets the movable range so that the shape of the movable area on the projection plane is a rectangle.

3. The information storage medium as defined in claim 1,
wherein the movable range setting section sets the movable range so that the shape of the movable area on the projection plane is an ellipse.

4. The information storage medium as defined in claim 1,
wherein the movable range setting section sets the movable range so that the shape of the movable area on the projection plane is an oval.

5. The information storage medium as defined in claim 1,
wherein an axis parallel to the parent bone is set to be an x-axis, and two axes that are orthogonal to the parent bone and are orthogonal to each other are set to be a y-axis and a z-axis, respectively;
wherein two coordinate axes on the projection plane that are orthogonal to each other are set to be an s-axis and a t-axis, respectively; and
wherein the coordinate transformation section transforms a point (x, y, z) on the sphere surface into a point (s, t) on the projection plane by a projection indicated by s=−z/(x+1) and t=y/(x+1) (where, x²+y²+z²=1) based on coordinate data of the focus.

6. The information storage medium as defined in claim 5,
wherein a rectangular shape, an elliptical shape, or an oval shape is set in advance as the shape of the movable area on the projection plane, and allowable ranges of a rotation angle of the child bone around the y-axis and a rotation angle of the child bone around the z-axis with respect to the joint are set in advance; and
wherein the movable range setting section sets the movable range of the joint on the projection plane based on the shape of the movable area on the projection plane and the allowable ranges of the rotation angle of the child bone around the y-axis and the rotation angle of the child bone around the z-axis.

7. The information storage medium as defined in claim 1,
wherein the skeleton motion calculation section determines whether or not the direction of the child bone with respect to the parent bone obtained by calculating the motion of the child bone corresponding to the motion of the parent bone is within the movable range, and corrects the direction of the child bone with respect to the parent bone so that a condition corresponding to the shape of the movable area is satisfied when the direction of the child bone with respect to the parent bone is not within the movable range.

8. The information storage medium as defined in claim 1,
wherein the skeleton motion calculation section determines whether or not the direction of the child bone with respect to the parent bone obtained by calculating the motion of the child bone corresponding to the motion of the parent bone is within the movable range, calculates a repulsion behavior in collision between the point projected onto the projection plane and a boundary of the movable range on the projection plane when the direction of the child bone with respect to the parent bone is not within the movable range, and corrects the direction of the child bone with respect to the parent bone.

9. The information storage medium as defined in claim 8,
wherein the skeleton motion calculation section calculates a time required for the repulsion behavior of the point projected onto the projection plane to converge when the repulsion behavior of the point projected onto the projection plane repeatedly occurs, and terminates the repulsion behavior of the point projected onto the projection plane when the time is equal to or shorter than a predetermined time.

10. The information storage medium as defined in claim 8,
wherein the skeleton motion calculation section corrects the direction of the child bone with respect to the parent bone so that a condition corresponding to the shape of the movable area is satisfied when a point on the projection plane obtained by calculating the repulsion behavior of the point projected onto the projection plane at the boundary of the movable range is not within the movable range.

11. A skeleton motion control device that control a motion of a skeleton model in which a parent bone and a child bone are linked via a joint, the device comprising:
a movable range setting section that sets a movable range of the joint on a projection plane, the projection plane being a plane that is orthogonal to an axis that connects a center point of a sphere and a focus that is a given point on the sphere surface, the center point of the sphere being the joint;
a coordinate transformation section that projects a point on the sphere surface onto the projection plane based on the focus, the point indicates a direction of the child bone; and
a skeleton motion calculation section that calculates the direction of the child bone with respect to the parent bone within the movable range based on a position of the point projected onto the projection plane.

12. A skeleton motion control method that is implemented by a processor included in a skeleton motion control device to control a motion of a skeleton model in which a parent bone and a child bone are linked via a joint, the method comprising:
setting a movable range of the joint on a projection plane, the projection plane being a plane that is orthogonal to an axis that connects a center point of a sphere and a focus that is a given point on the sphere surface, the center point of the sphere being the joint;
projecting a point on the sphere surface onto the projection plane based on the focus, the point indicates a direction of the child bone; and
calculating the direction of the child bone with respect to the parent bone within the movable range based on a position of the point projected onto the projection plane.
